(19) United States
(12) Patent Application Publication
(10) Pub. No.: US 2011/0212791 A1
(43) Pub. Date: Sep. 1, 2011

(54) DIAGNOSING METHOD OF GOLF SWING AND SILHOUETTE EXTRACTING METHOD

(75) Inventors: Masahiko UEDA, Kobe-shi (JP); Yoshiaki SHIRAI, Osaka (JP); Nobutaka SHIMADA, Osaka (JP)

(73) Assignees: Yoshiaki Shirai, Osaka (JP); Nobutaka Shimada, Osaka (JP); SRI SPORTS LIMITED, Kobe-shi (JP); SUMITOMO RUBBER INDUSTRIES, LTD., Kobe-shi (JP)

(21) Appl. No.: 13/036,699

(22) Filed: Feb. 28, 2011

(30) Foreign Application Priority Data
Mar. 1, 2010 (JP) 2010-044122

(51) Int. Cl. A63B 69/36; G06K 9/00

(52) U.S. Cl. 473/221; 473/409; 382/168

(57) ABSTRACT

In a method capable of diagnosing quality of a swing without circumstance, a camera 10 photographs a golf player swinging a golf club to hit a golf ball and the golf club. Image data is obtained by photographing. A calculating part 16 extracts a frame from the image data. The calculating part 16 obtains an edge image of the frame. The calculating part 16 subjects the edge image to binarization based on a predetermined threshold value to obtain a binary image. The calculating part 16 subjects the binary image to Hough transform processing to extract a position of a shaft of the golf club, and specifies a tip coordinate of the golf club. The calculating part 16 contrasts tip coordinates of different frames to determine a temporary flame in an address. The calculating part 16 calculates color information in a reference area of each of the frames by backward sending from a frame after the temporary frame by a predetermined number, and determines a frame in the address based on change of the color information.

This application claims priority on Patent Application No. 2010-044122 filed in JAPAN on Mar. 1, 2010, the entire contents of which are hereby incorporated by reference.

### BACKGROUND OF THE INVENTION

1. Field of the Invention

The present invention relates to a method for diagnosing quality of a golf swing, and a method for extracting silhouette of a photographic subject conducting operations of sports or the like.

2. Description of the Related Art

When a golf player hits a golf ball, the golf player addresses so that a line connecting right and left tiptoes is approximately parallel to a hitting direction. In a right-handed golf player's address, a left foot is located on a front side in the hitting direction, and a right foot is located on a back side in the hitting direction. In the address, a head of a golf club is located near the golf ball. The golf player starts a takeback from this state, and raises up the head backward and then upward. A position where the head is fully raised up is a top. A downswing is started from the top. A start point of the downswing is referred to as a quick turn. The head is swung down after the quick turn, and the head collides with the golf ball (impact). After the impact, the golf player swings through the golf club forward and then upward (follow-through), and reaches a finish.

In improvement in skill of a golf player, it is important to acquire a suitable swing form. Swing diagnosis is conducted so as to contribute to the improvement in the skill. In the swing diagnosis, a swing is photographed by a video camera. The swing may be photographed in order to collect materials useful for development of golf equipment.

In classic swing diagnosis, a teaching pro or the like views a moving image and points out problems during a swing. On the other hand, an attempt to diagnose the swing using image processing is also conducted. In the image processing, a frame required for diagnose is needs to be extracted from a large number of frames. An example of the extracting method is disclosed in Japanese Patent Application Laid-Open No. 2005-210666. In the method, extraction is conducted by difference processing. As a gazette of the patent family of the gazette, US2005143183 (A1) and U.S. Pat. No. 7,502,491 (B2) exist.

In the image processing, it to necessary to discriminate between a pixel in which a golf player is photographed and a pixel in which a background scene is photographed. Golf player's silhouette can be extracted by the discrimination. Difference processing is usually used for the discrimination. In the processing, the background scene is previously photographed. The golf player is then photographed. A difference between an image in which only the background scene is photographed and an image in which the background scene and the golf player are photographed discriminates between the golf player and the background scene. Specifically, a pixel in which color information is same in both the images is judged as the background scene, and a pixel other than the background scene is judged as the golf player (or the golf club). The diagnosing method is disclosed in Japanese Patent application Laid-Open No. 2005-270534. As a gazette of the patent family of the gazette, US2005215337 (A1) and U.S. Pat. No. 7,704,157 (B2) exist.

A golf club in which a mark is attached to a shaft is used in the method disclosed in Japanese Patent Application Laid-Open No. 2005-210666. The golf club needs to be preliminarily prepared. The method is suitable for diagnosis conducted based on photographing at a golf equipment shop. However, the method is unsuitable for diagnosis when a common golf club is swung in a golf course or a driving range.

The weather may change between photographing of the background scene and photographing of the swing. For example, although the weather is cloudy in photographing the background scene, sunlight may shine in photographing the swing. When a shadow is generated by the sunlight, color information of the pixel of the shadow is different from that when the background scene is photographed. Therefore, the pixel of the background scene is falsely recognized as the pixel of the golf player by the difference processing. The false recognition blocks accuracy of extraction of silhouette. The golf player desires accurate silhouette extraction. The accurate silhouette extraction is desired also in various sports such as baseball and tennis.

### SUMMARY OF THE INVENTION

It is an object of the present invention to provide a method for diagnosing quality of a swing without circumstance, and a method capable of extracting silhouette of a photographic subject with sufficient accuracy.

A diagnosing method of a golf swing according to the present invention comprises the steps of:

a camera photographing a golf player swinging a golf club to hit a golf ball and the golf club, to obtain image data;

a calculating part obtaining an edge image of a frame extracted from the image data;

the calculating part subjecting the edge image to binarization based on a predetermined threshold value to obtain a binary image; and

the calculating part subjecting the binary image to Hough transform processing to extract a position of a shaft.

A diagnosing system of a golf swing according to the present invention comprises:

(A) a camera photographing a golf player swinging a golf club to hit a golf ball and the golf club;

(B) a memory storing photographed image data; and

(C) a calculating part,

wherein the calculating part has:

(C1) a function for obtaining an edge image of a frame extracted from the image data;

(C2) a function for subjecting the edge image to binarization based on a predetermined threshold value to obtain a binary image; and

(C3) a function for subjecting the binary image to Hough transform processing to extract a position of a shaft.

According to another view, a diagnosing method of a golf swing according to the present invention comprises the steps of:

a camera photographing a golf player swinging a golf club to hit a golf ball and the golf club in a state where a golf club head in an address is positioned in a reference area in a screen to obtain image data;

a calculating part obtaining an edge image of a frame extracted from the image data;

the calculating part subjecting the edge image to binarization based on a predetermined threshold value to obtain a binary image;

the calculating part subjecting the binary image to Hough transform processing to extract a position of a shaft of the golf club, and specifying a tip coordinate of the golf club;

the calculating part contrasting tip coordinates of different frames to determine a temporary flame in the address; and

the calculating part calculating color information in the reference area of each of frames by backward sending from a frame after the temporary frame by a predetermined number, and determining a frame in the address based on change of the color information.

Preferably, the diagnosing method comprises the step of the calculating part using a frame after the frame in the address by a predetermined number as a reference frame, calculating a difference value between each of frames after the reference frame and the reference frame, and determining a frame of an impact based on change of the difference value.

Preferably, the diagnosing method further comprises the steps of the calculating part calculating a difference value between each of a plurality of frames before the frame of the impact and a previous frame thereof, and determining a frame of a top based on the difference value.

Preferably, the diagnosing method further comprises the steps of:

the calculating part calculating a difference value between each of a plurality of frames after the frame of the address and the frame of the address;

the calculating part subjecting the difference value of each of the frames to Hough transform processing to extract the position of the shaft; and

the calculating part determining a frame of a predetermined position during a takeback based on change of the position of the shaft.

According to another view, a diagnosing system of a golf swing according to the present invention comprises:

(A) a camera photographing a golf player swinging a golf club to hit a golf ball and the golf club in a state where a golf club head in an address is positioned in a reference area in a screen;

(B) a memory storing the photographed image data; and

(C) a calculating part,

wherein the calculating part has:

(C1) a function for obtaining an edge image of a frame extracted from the image data;

(C2) a function for subjecting the edge image to binarization based on a predetermined threshold value to obtain a binary image;

(C3) a function for subjecting the binary image to Hough transform processing to extract a position of a shaft of the golf club, and specifying a tip coordinate of the golf club;

(C4) a function for contrasting tip coordinates of different frames to determine a temporary flame in the address; and

(C5) a function for calculating color information in the reference area of each of frames by backward sending from a frame after the temporary frame by a predetermined number, and determining a frame in the address based on change of the color information.

According to another view, a diagnosing method of a golf swing according to the present invention comprises the steps of:

a camera photographing a golf player swinging a golf club to hit a golf ball and the golf club, to obtain image data;

a calculating part determining a frame of a predetermined position during a takeback from a frame extracted from the image data;

the calculating part extracting a position of a shaft of the golf club in the frame of the predetermined position;

the calculating part determining an intersecting point of an extended line of the shaft and a straight line passing through a tiptoe position of golf player and a position of the golf ball before an impact; and

the calculating part determining quality of a posture of the golf player in the predetermined position during the takeback based on a position of the intersecting point.

A silhouette extracting method according to the present invention comprises the steps of:

photographing an operating photographic subject together with a background scene to obtain a plurality of flames, each of the frames including a large number of pixels;

producing a whole frame set including all the frames for each of the pixels;

determining whether each of the pixels of each of the frames has an achromatic color or a chromatic color, and producing a chromatic color frame set and an achromatic color frame set for each of the pixels;

producing a first histogram in which a frequency is a frame number and a class is first color information, for the whole frame set;

producing a second histogram in which a frequency is a frame number; a class for the chromatic color frame set is second color information; and a class for the achromatic color frame set is third color information, for the chromatic color frame set and the achromatic color frame set; and

deciding whether the frame of each of the pixels is the background scene or the photographic subject based on the first histogram and the second histogram.

Preferably, the deciding step comprises the step of deciding whether each of the pixels is a pixel in which all the frames are the background scene or a pixel in which a frame as the background scene and a frame as the photographic subject are mixed, based on the first histogram and the second histogram.

Preferably, the deciding step comprises the steps of:

deciding whether the pixel in which the frame as the background scene and the frame as the photographic subject are mixed is a pixel in which a frame group as the background scene can be discriminated from a frame group as the photographic subject, based on the first histogram and the second histogram; and

discriminating the pixel in which the frame group as the background scene can be discriminated from the frame group as the photographic subject.

Preferably, the deciding step comprises the step of determining whether each of the frames of the pixel determined that the frame group as the background scene cannot be discriminated from the frame group as the photographic subject is the background scene or the photographic subject, based on the relationship between the pixel and another pixel adjacent to the pixel.

A silhouette extracting system according to the present invention comprises:

(A) a camera for photographing an operating photographic subject together with a background scene;

(B) a memory storing photographed image data; and

(C) a calculating part,

wherein the calculating part comprises:

(C1) a frame extracting part extracting a plurality of frames including a large number of pixels from the image data;

(C2) a first set producing part producing a whole frame set including all the frames for each of the pixels;

(C3) a second set producing part determining whether each of the pixels of each of the frames has an achromatic color or a chromatic color, and producing a chromatic color frame set and an achromatic color frame set for each of the pixels;

(C4) a first histogram producing part producing a first histogram in which a frequency is a frame number and a class is first color information, for the whole frame set;

(C5) a second histogram producing part producing a second histogram in which a frequency is a frame number; a class for the chromatic color frame set is second color information; and a class for the achromatic color frame set is third color information, for the chromatic color frame set and the achromatic color frame set; and

(C6) a deciding part deciding whether each of the frames of each of the pixels is the background scene or the photographic subject based on the first histogram and the second histogram.

### BRIEF DESCRIPTION OF THE DRAWINGS

FIG. 1 is a conceptual view showing a golf swing diagnosing system according to one embodiment of the present invention;

FIG. 2 is a flow chart showing a diagnosing method of a golf swing conducted by the system of FIG. 1;

FIG. 3 is an illustration showing a screen of a camera of FIG. 1;

FIG. 4 is a flow chart showing a method of determining a check frame;

FIG. 5 is a flow chart showing a method determining a frame of an address;

FIG. 6 is an illustration for a Sobel method;

FIG. 7 is a binarized image;

FIG. 8 is a flow chart showing a method determining a frame of an impact;

FIG. 9 is an image showing a result of a difference between a 44th frame and a reference frame;

FIG. 10 is an image showing a result of a difference between a 62th frame and a reference frame;

FIG. 11 is an image showing a result of a difference between a 75th frame and a reference frame;

FIG. 12 is an image showing a result of a difference between a 76th frame and a reference frame;

FIG. 13 is an image showing a result of a difference between a 77th frame and a reference frame;

FIG. 14 is an image showing a result of a difference between a 78th frame and a reference frame;

FIG. 15 is a graph showing a difference value;

FIG. 16 is a flow chart showing a method determining a frame of a top;

FIG. 17 is a graph showing a difference value;

FIG. 18 is a flow chart showing a method determining a frame of a predetermined position of a takeback;

FIG. 19 is an image showing a result of a difference between a 30th frame and a reference frame;

FIG. 20 is an image showing a result of a difference between a 39th frame and a reference frame;

FIG. 21 is an image showing a result of a difference between a 41th frame and a reference frame;

FIG. 22 is an image showing a result of a difference between a 43th frame and a reference frame;

FIG. 23 is an image showing a result of a difference between a 52th frame and a reference frame;

FIG. 24 is an image showing a result of a difference between a 57th frame and a reference frame;

FIG. 25 is a flow chart showing an example of a decision;

FIG. 26 is an image showing a result of a difference;

FIG. 27 is an illustration for a reference point;

FIG. 28 is an illustration for a temporary foot searching area;

FIG. 29 is an illustration for a foot searching area;

FIG. 30 is an illustration for a sample area;

FIG. 31 is a histogram of D(V_{x,y});

FIG. 32 is an image showing a result of a difference between a frame in which a left arm is horizontal in a takeback and a frame of an address;

FIG. 33 is an illustration for a valuating method;

FIG. 34 is a conceptual view showing a silhouette extracting system according to one embodiment of the present invention;

FIG. 35 is a conceptual view showing the details of a calculating part of the system of FIG. 34;

FIG. 36 is a flow chart showing a silhouette extracting method conducted by the system of FIG. 34;

FIG. 37 is an illustration showing a screen of a camera of FIG. 34;

FIG. 38 is an illustration showing a mask for the silhouette extracting method of FIG. 36;

FIG. 39 is a flow chart showing the details of a step of a part of the silhouette extracting method of FIG. 36;

FIG. 40 is a luminance histogram of a certain pixel;

FIG. 41 is a luminance histogram of another pixel;

FIG. 42 is a luminance histogram of still another pixel;

FIG. 43 is a color histogram of the pixel of FIG. 40;

FIG. 44 is a color histogram of the pixel of FIG. 41;

FIG. 45 is a color histogram of the pixel of FIG. 42;

FIG. 46 is a flow chart showing a first stage of a deciding step of the method of FIG. 36;

FIG. 47 is a flow chart showing a second stage of the deciding step of the method of FIG. 36;

FIG. 48 is a flow chart showing a third stage of the deciding step of the method of FIG. 36;

FIG. 49 is an illustration showing silhouette obtained by the method of FIG. 36; and

FIG. 50 is a conceptual view showing a silhouette extracting system according to another embodiment of the present invention.

### DESCRIPTION OF THE PREFERRED EMBODIMENTS

Hereinafter, the present invention will be described below in detail based on preferred embodiments with reference to the drawings.

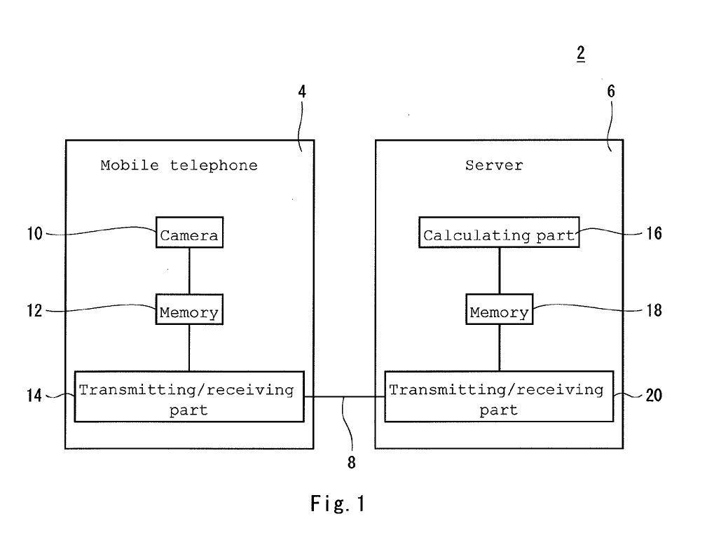

A system 2 shown in FIG. 1 is provided with a mobile telephone 4 and a server 6. The mobile telephone 4 and the server 6 are connected each other via a communication line 8. The mobile telephone 4 is provided with a camera 10, a memory 12, and a transmitting/receiving part 14. Specific examples of the memory 12 include a RAM, an SD card (including a mini SD and a micro SD or the like), and other memory medium. The server 6 is provided with a calculating part 16, a memory 18, and a transmitting/receiving part 20. The calculating part 16 is typically a CPU.

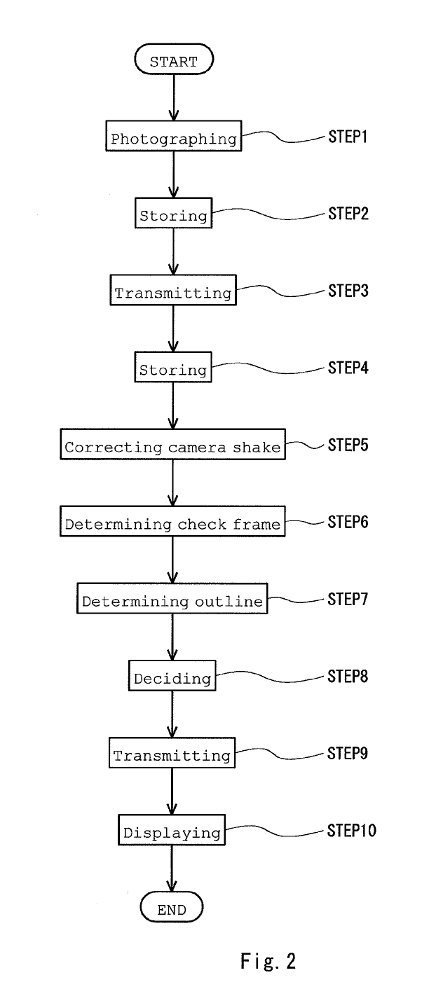

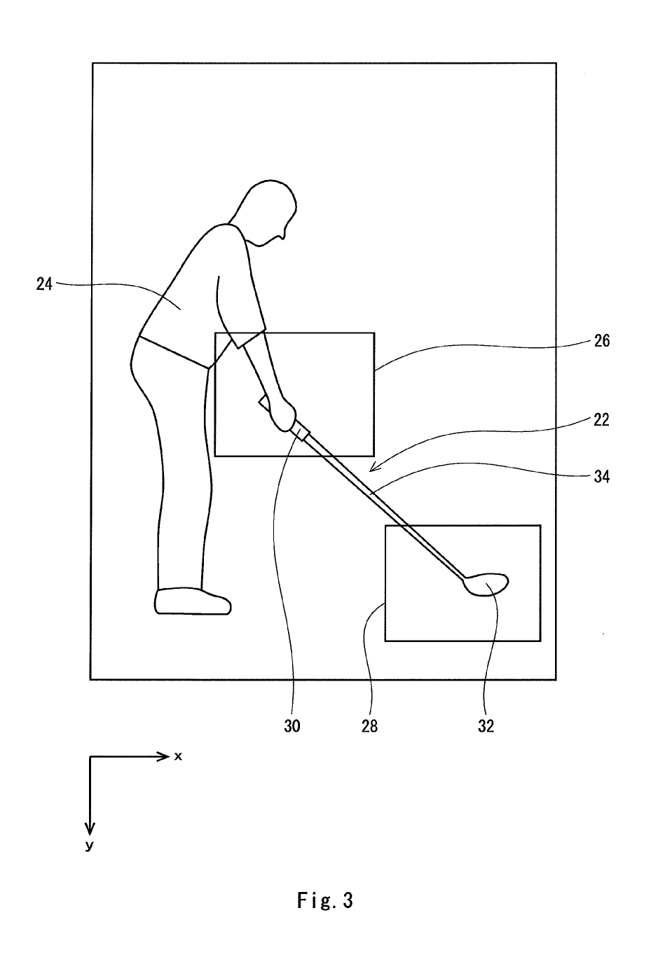

A flow chart of diagnosing method of a golf swing conducted by the system 2 of FIG. 1 is shown in FIG. 2. In the diagnosing method, photographing is conducted by the camera 10 (STEP1). A screen before photographing is started is shown in FIG. 3. The screen is displayed on a monitor (not shown) of the mobile telephone 4. An address of a golf player 24 having a golf club 22 is photographed on the screen. On the screen, the golf player 24 is photographed from a back side. A first frame 26 and a second frame 28 are shown on the screen. These frames 26 and 28 are displayed by software executed on a CPU (not shown) of the mobile telephone 4. The frames 26 and 28 contribute to a case where a photographer determines an angle of the camera 10. The photographer determines an angle of the camera 10 so that the first frame 26 includes a grip 30 and the second frame 28 includes a head 32. Furthermore, the frames 26 and 28 contribute to determination of a distance between the camera 10 and the golf player 24.

Photographing is started from the state shown in FIG. 3. After the photographing is started, the golf player 24 starts a swing. The photographing is continued until a golf ball (not shown) is hit and the swing is ended. Moving image data is obtained by the photographing. The data includes a large number of frames. These frames are stored in the memory 12 (STEP2). The number of pixels of each of the frames is, for example, 640×480. Each of the pixels has RGB system color information.

The photographer or the golf player 24 operates the mobile telephone 4 to transmit the moving image data to the server 6 (STEP3). The data is transmitted to the transmitting/receiving part 20 of the server 6 from the transmitting/receiving part 14 of the mobile telephone 4. The transmission is conducted via the communication line 8. The data is stored in the memory 18 of the server 6 (STEP4).

The calculating part 16 conducts camera shake correction (STEP5). As described in detail later, the diagnosing method according to the present invention conducts difference processing between the frames. The camera shake correction enhances accuracy in the difference processing. An example of a method for the camera shake correction is disclosed in Japanese Patent Application No. 2009-230385. When the mobile telephone 4 has a sufficient camera shake correction function, the camera shake correction conducted by the calculating part 16 can be omitted.

The calculating part 16 determines a frame presented in order to decide quality of a swing from a large number of frames (STEP6). Hereinafter, the frame is referred to as a check frame. For example, frames corresponding to the following items (1) to (6) are extracted:

(1) an address
(2) a predetermined position during a takeback
(3) a top
(4) a quick turn
(5) an impact
(6) a finish
The predetermined position during the takeback includes a position where an arm is horizontal. The quick turn implies a state immediately after start of the downswing. In the quick turn, the arm is substantially horizontal. The details of an extracting step (STEP6) of the check frame will be described later.

The calculating part 16 determines an outline of each of the check frames (STEP7). Specifically, the calculating part 16 determines an outline of a body of the golf player 24 or an outline of the golf club 22. The calculating part 16 decides the quality of the swing based on the outline (STEP8).

The deciding result is transmitted to the transmitting/receiving part 14 of the mobile telephone 4 from the transmitting/receiving part 20 of the server 6 (STEP9). The deciding result is displayed on the monitor of the mobile telephone 4 (STEP10). The golf player 24 viewing the monitor can know a portion of the swing which should be corrected. The system 2 can contribute to improvement in skill of the golf player 24.

As described above, the calculating part 16 determines the check frame (STEP6). The calculating part 16 has the following functions:

(1) a function for obtaining an edge image of a frame extracted from the image data;

(2) a function for subjecting the edge image to binarization based on a predetermined threshold value to obtain a binary image;

(3) a function for subjecting the binary image to Hough transform processing to extract a position of a shaft 34 of the golf club 22, and specifying a tip coordinate of the golf club 22;

(4) a function for contrasting tip coordinates of different frames to determine a temporary flame in the address;

(5) a function for calculating color information in the reference area of each of frames by backward sending from a frame after the temporary frame by a predetermined number, and determining a frame in the address based on change of the color information;

(6) a function for using a frame after the frame in the address by a predetermined number as a reference frame, calculating a difference value between each of frames after the reference frame and the reference frame, and determining a frame of an impact based on change of the difference value;

(7) a function for calculating a difference value between each of a plurality of frames before the frame of the impact and a previous frame thereof, and determining a frame of a top based on the difference value;

(8) a function for calculating a difference value between each of a plurality of frames after the frame of the address and the frame of the address;

(9) a function for subjecting the difference value of each of the frames to Hough transform processing to extract the position of the shaft 34; and

(10) a function for determining a frame of a predetermined position during a takeback based on change of the position of the shaft 34.

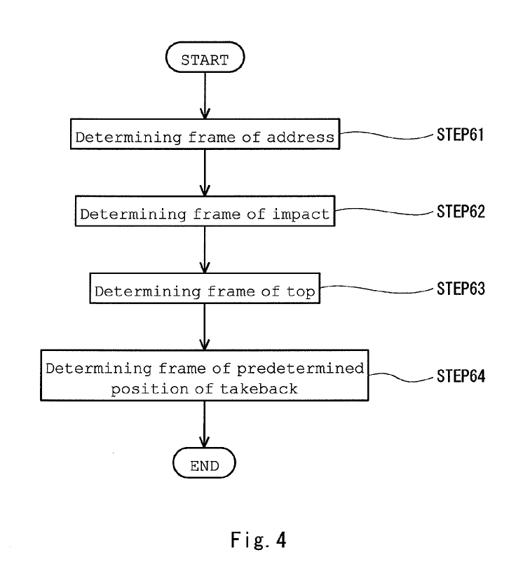

A flow chart of a determining method of the check frame is shown in FIG. 4. The determining method includes a step of determining the frame of the address (STEP61), a step of determining the frame of the impact (STEP62), a step of determining the frame of the top (STEP63), and a step of determining the frame of the predetermined position of the takeback (STEP64). The predetermined position of the takeback is, for example, a position where the arm is horizontal.

Other check frame may be determined based on the frame determined by the method shown in FIG. 4. For example, a frame before the frame of the impact by a predetermined number can be defined as a frame of a quick turn. A frame after the frame of the impact by a predetermined number can be defined as a frame of a finish.

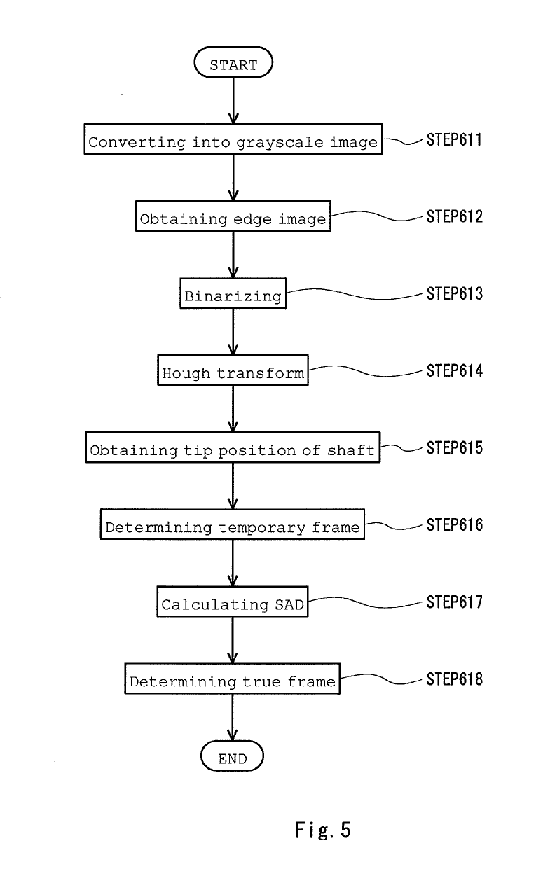

A flow chart of a method for determining the frame of the address is shown in FIG. 5. In the method, each of the frames is converted into a grayscale image from an RGB image (STEP611). The conversion is conducted in order to facilitate subsequent edge detection. A value V in the grayscale image is calculated by, for example, the following numerical expression.

V=0.30·R+0.59·G+0.11·B

The edge is detected from the grayscale image and the edge image is obtained (STEP612). In the edge, change of a value V is great. Therefore, the edge can be detected by differentiating or taking differences of the change of the value V. A noise is preferably removed in the calculation of the differentiation or the difference. A Sobel method is exemplified as an example of the method for detecting the edge. The edge may be detected by other method. A Prewitt method is exemplified as the other method.

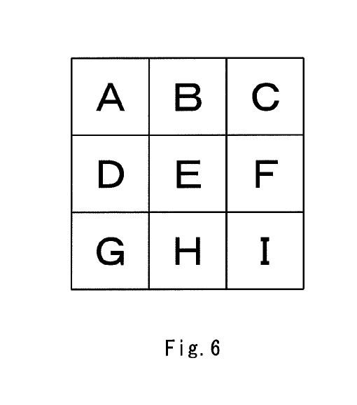

FIG. 6 is an illustration for the Sobel method. Characters A to I in FIG. 6 represent values V of the pixels. A value E′ is calculated from a value E by the Sobel method. The value E′ is edge intensity. The value E′ is obtained by the following numerical expression.

E′=(fₓ²+f_{y}²)^{1/2}

In the numerical expression, fₓ and f_{y} are obtained by the following numerical expression.

fₓ=C+2·F+I−(A+2·D+G)

f_{y}=G+2·H+I−(A+2·B+C)

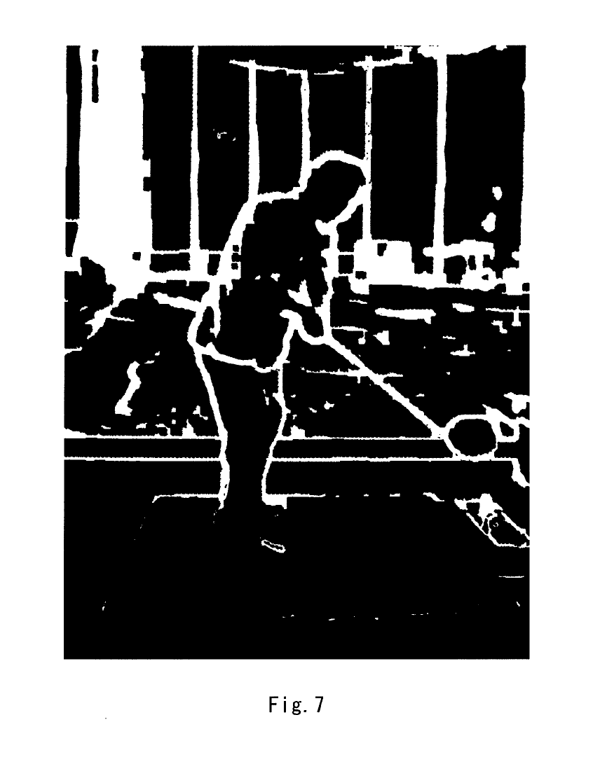

Each of the pixels of the edge image is binarized (STEP613). A threshold value for binarization is suitably determined according to the weather and the time or the like. A monochrome image is obtained by the binarization. An example of the monochrome image is shown in FIG. 7.

Data of the monochrome image is presented for Hough transform (STEP614). The Hough transform is a method for extracting a line from an image using regularity of a geometric shape. A straight line, a circle, and an ellipse or the like can be extracted by the Hough transform. In the present invention, a straight line corresponding to the shaft 34 of the golf club 22 is extracted by the Hough transform.

The straight line can be represented by an angle θ between a line perpendicular to the straight line and an x-axis, and a distance ρ between the straight line and a origin point. The angle θ is a clockwise angle having a center on the origin point (0, 0). The origin point is on the upper left. The straight line on an x-y plane corresponds to a point on a θ-ρ plane. On the other hand, a point (xᵢ, yᵢ) on the x-y plane is converted into a sine curve represented by the following numerical expression on the θ-ρ plane.

ρ=xᵢ·cos θ+yᵢ·sin θ

When points which are on the same straight line on the x-y plane are converted into the θ-ρ plane, all sine curves cross at one point. When a point through which a large number of sine curves pass in the θ-ρ plane becomes clear, the straight line on the x-y plane corresponding to the point becomes clear.

Extraction of a straight line corresponding to the shaft 34 is attempted by the Hough transform. In a frame in which the shaft 34 is horizontal in the takeback, an axis direction of the shaft 34 approximately coincides with an optical axis of the camera 10. In the frame, the straight line corresponding to the shaft 34 cannot be extracted. In the embodiment, ρ is not specified; θ is specified as 30 degrees or greater and 60 degrees or less; x is specified as 200 or greater and 480 or less; and y is specified as 250 or greater and 530 or less. Thereby, the extraction of the straight line is attempted. Since θ is specified as the range, a straight line corresponding to an erected pole is not extracted. A straight line corresponding to an object placed on the ground and extending in a horizontal direction is also not extracted. False recognition of a straight line which does not correspond to the shaft 34 as the straight line corresponding to the shaft 34 is prevented by specifying θ as 30 degrees or greater and 60 degrees or less. In the embodiment, in straight lines in which the number of votes (the number of pixels through which one straight line passes) is equal to or greater than 150, a straight line having the greatest number of votes is regarded as the straight line corresponding to the shaft 34. In the frame in which the straight line corresponding to the shaft 34 is extracted by the Hough transform, the tip coordinate of the shaft 34 (the tip position of the straight line) is obtained (STEP615).

In the embodiment, the tip coordinate is obtained by backward sending from a 50th frame after the photographing is started. A frame in which the moving distance of the tip between the frame and both the preceding and following frames is equal to or less than a predetermined value is determined as a temporary frame of the address (STEP616). In the embodiment, a f-th frame in which a tip is in the second frame 28 (see FIG. 3) and the summation of the moving distances of (f−1)th to (f+2)th tips is equal to or less than 40 is defined as a temporary frame.

SAD (color information) of a plurality of frames before and after the temporary frame is calculated (STEP617). SAD is calculated by the following numerical expression (1).

SAD=(RSAD+GSAD+BSAD)/3 (1)

In the numerical expression (1), RSAD is calculated by the following numerical expression (2); GSAD is calculated by the following numerical expression (3); and BSAD is calculated by the following numerical expression (4).

RSAD=(Rf1−Rf2)² (2)

GSAD=(Gf1−Gf2)² (3)

BSAD=(Bf1−Bf2)² (4)

In the numerical expression (2), Rf1 represents an R value in the f-th second frame 28; Rf2 represents an R value in the (f+1)-th second frame 28. In the numerical expression (3), Gf1 represents a G value in the f-th second frame 28; and Gf2 represents a G value in the (f+1)-th second frame 28. In the numerical expression (4), Bf1 represents a B value in the f-th second frame 28; and Bf2 represents a B value in the (f+1)-th second frame 28.

SAD of each of the frames is calculated by backward sending from a frame after the temporary frame by a predetermined number. In the embodiment, SAD of from a frame after the temporary frame by 7 to a frame before the temporary frame by 10 is calculated. A frame in which SAD is first less than 50 is determined as a true frame of the address (STEP618). The frame is the check frame. The outline of the check frame is determined (STEP7), and the quality of the swing is decided (STEP8). When the frame in which SAD is less than 50 does not exist, a frame in which SAD is the minimum is determined as the true frame of the address.

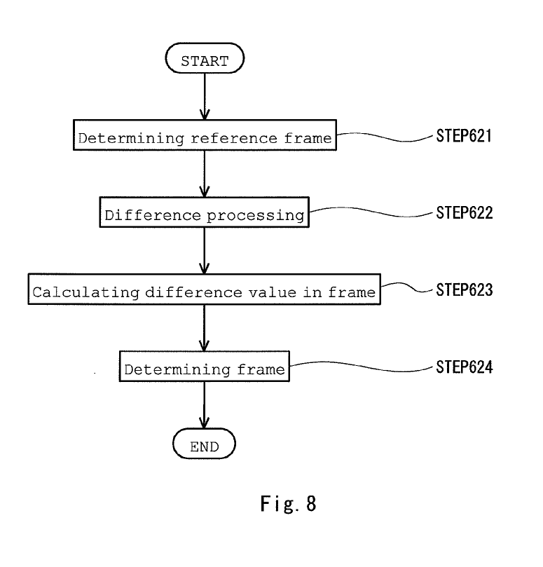

A flow chart of a method for determining the frame of the impact is shown in FIG. 8. Since the frame of the address has been already determined, the frame after the frame of the address by the predetermined number is determined as a reference frame (STEP621). The reference frame is a frame before the impact in which the golf club 22 is not positioned in the second frame 28. In the embodiment, a frame after the frame of the address by 25 is defined as the reference frame.

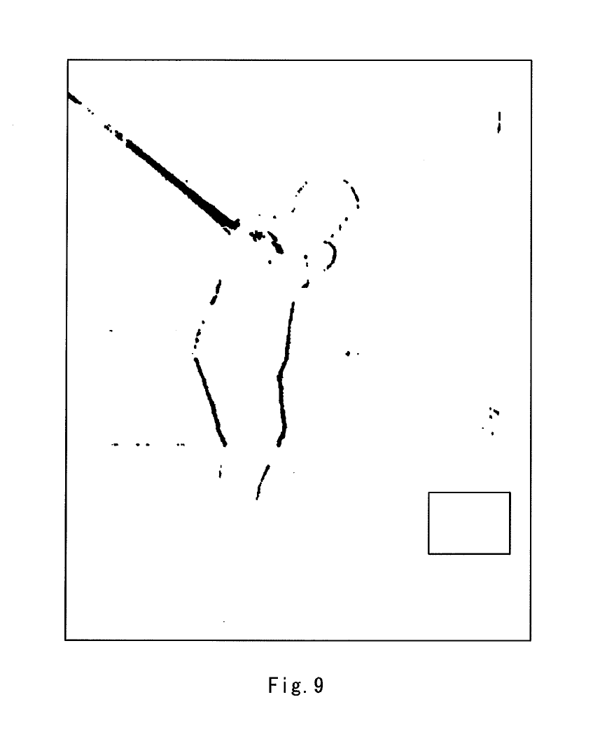

Difference processing is conducted between the reference frame and each of the frames after the reference frame (STEP622). The difference processing is processing known as one of image processings. Difference images are shown in FIGS. 9 to 14. The details of the images are as follows.

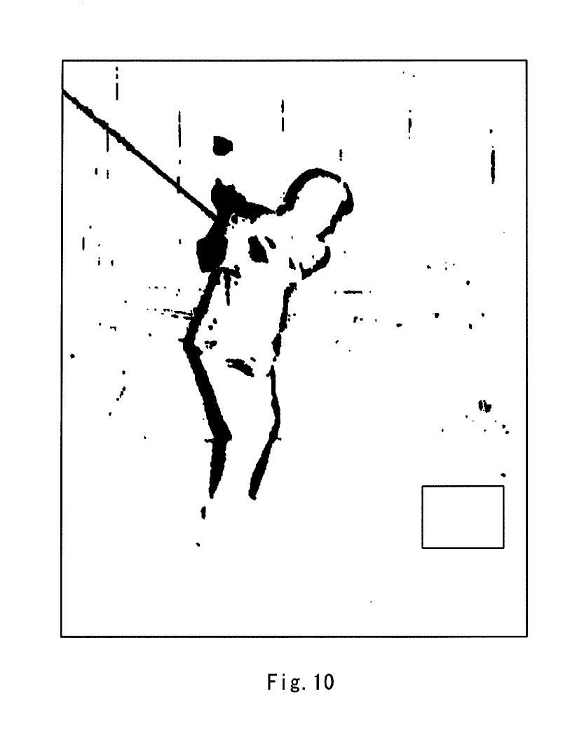

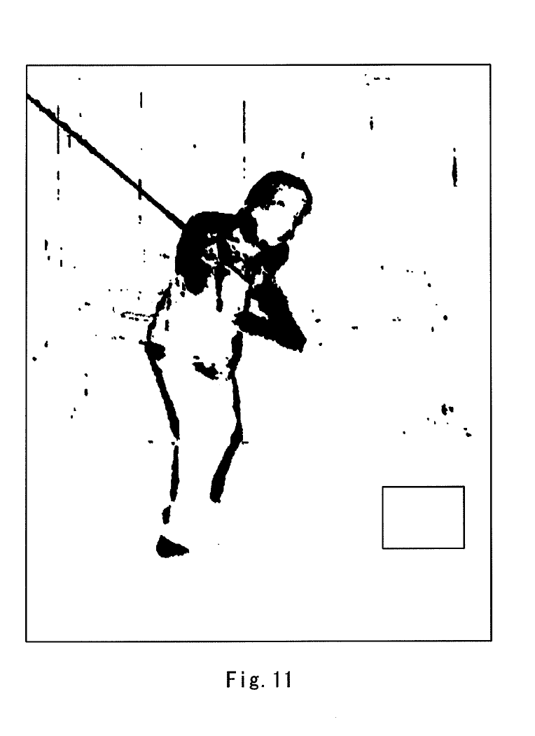

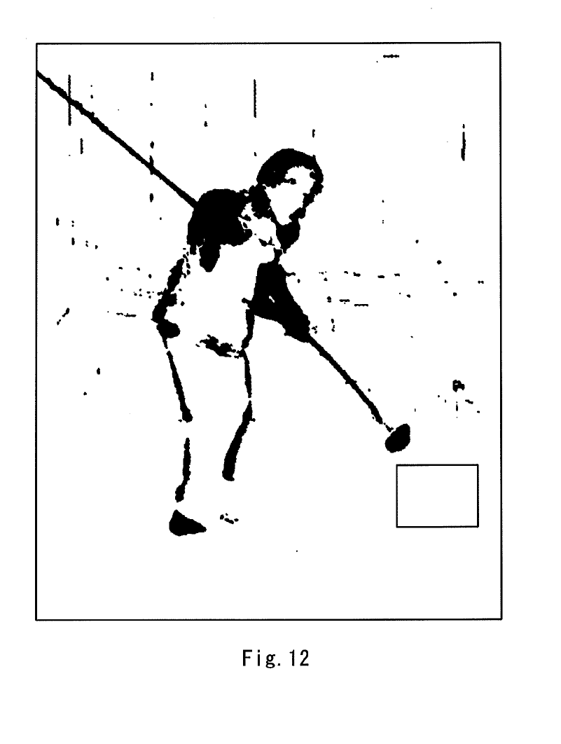

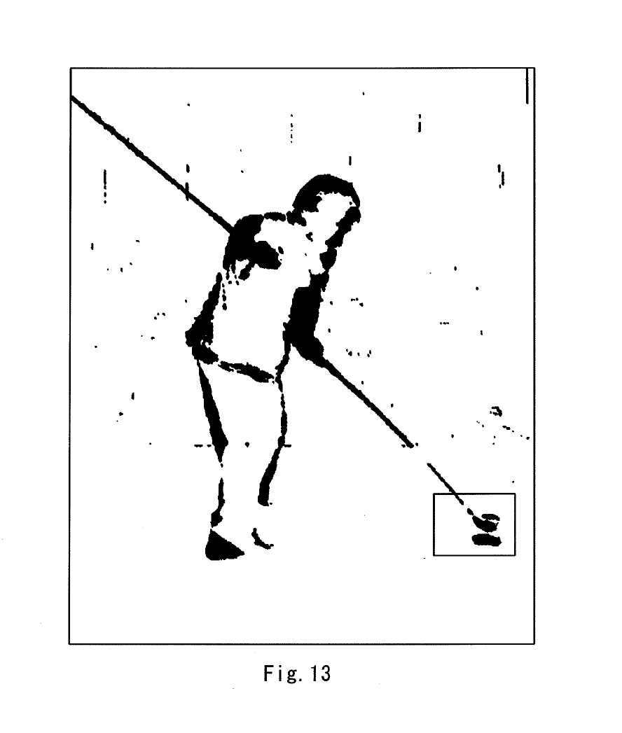

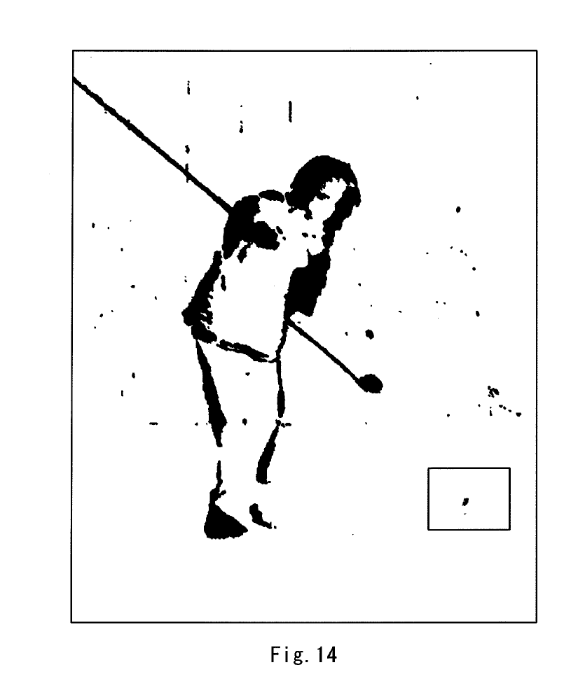

FIG. 9: A difference image between a 44th frame and the reference frame
FIG. 10: A difference image between a 62th frame and the reference frame
FIG. 11: A difference image between a 75th frame and the reference frame
FIG. 12: A difference image between a 76th frame and the reference frame
FIG. 13: A difference image between a 77th frame and the reference frame
FIG. 14: A difference image between a 78th frame and the reference frame

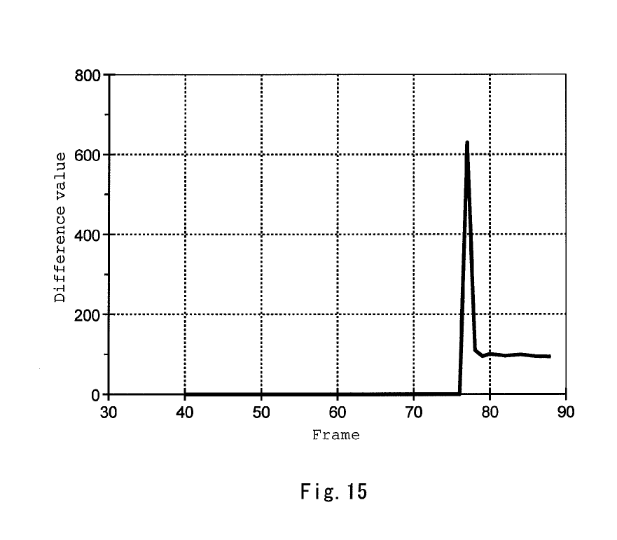

A difference value in the second frame 28 for the image after the difference processing is calculated (STEP623). The difference value is shown in a graph of FIG. 15. The graph shows that the difference value of the 77th frame is the largest. The 77th frame is determined as the frame of the impact (STEP624). The frame is the check frame. The outline of the check frame is determined (STEP7), and the quality of the swing is decided (STEP8).

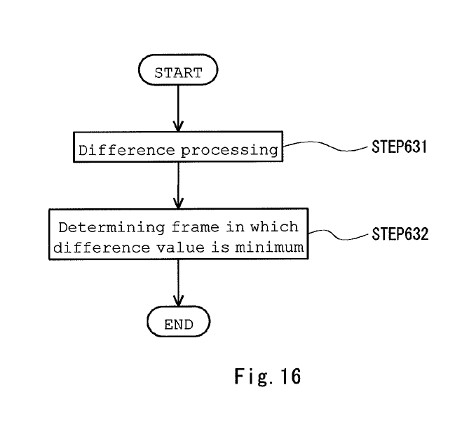

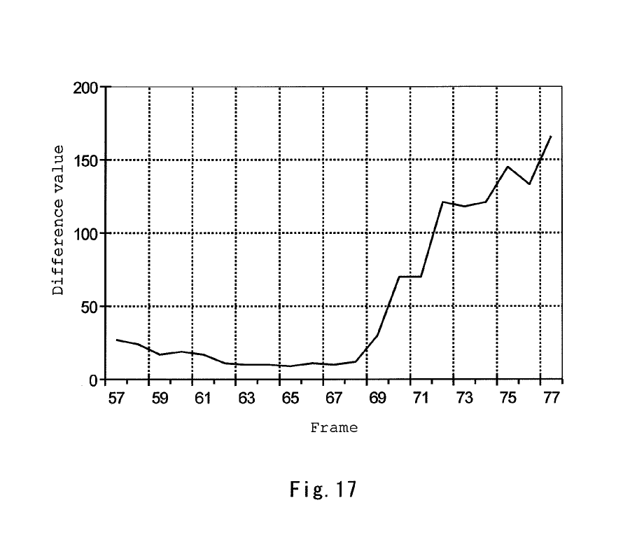

A flow chart of a method for determining the frame of the top is shown in FIG. 16. The frame of the impact has been already determined. Difference processing of from the frame of the impact to a frame before the impact by a predetermined number is conducted (STEP631). The difference processing is conducted between the frame and a frame after the frame by 1. A difference value is obtained by the difference processing. The difference value is shown in FIG. 17. In the embodiment, a frame in which a difference value is the minimum is selected between a frame before the impact by 15 and the frame of the impact (STEP632). In the example of FIG. 17, the 77th frame is the frame of the impact; and a 65th frame is the frame of the top. The 65th frame is the check frame. The outline of the check frame is determined (STEP7), and the quality of the swing is decided (STEP8).

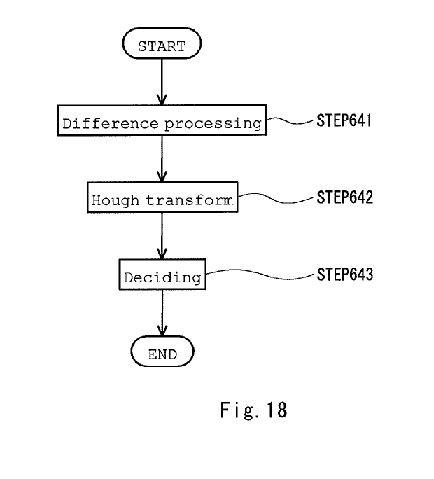

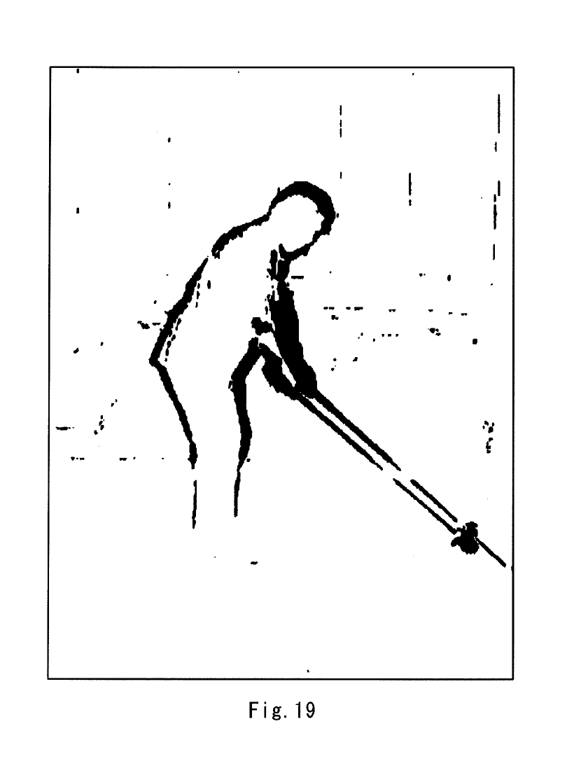

A flow chart of a method for determining the predetermined position of the takeback is shown in FIG. 18. The frame of the address has been already determined. The difference processing of frames after the frame of the address is conducted (STEP641). The frame of the address is used as the reference frame, and the difference processing is conducted between the reference frame and other frame. Difference images are shown in FIGS. 19 to 24. The details of the images are as follows.

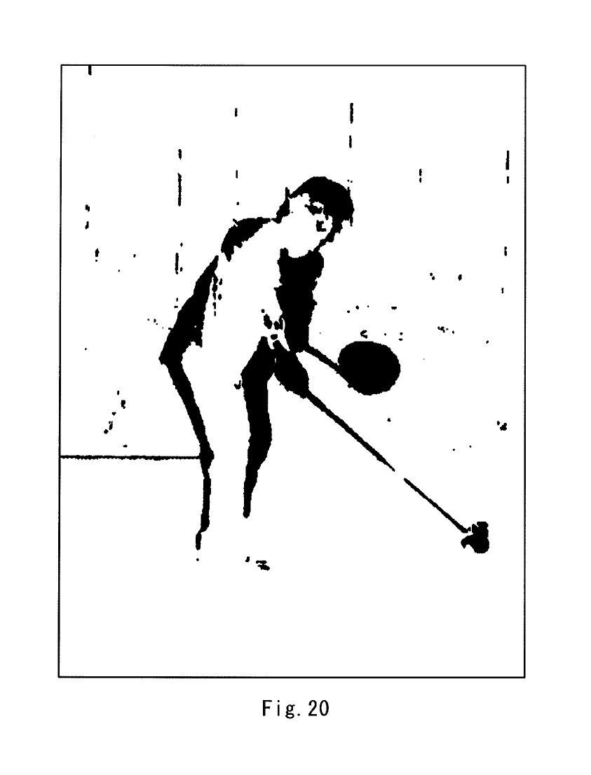

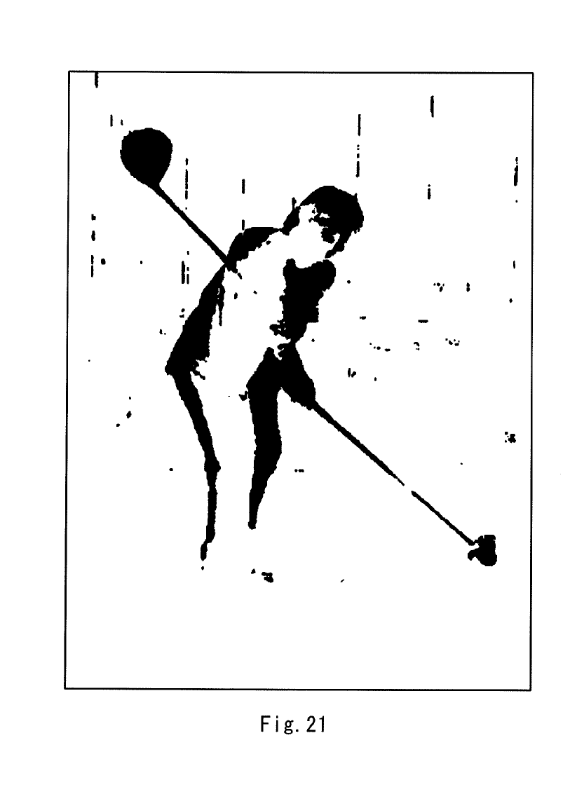

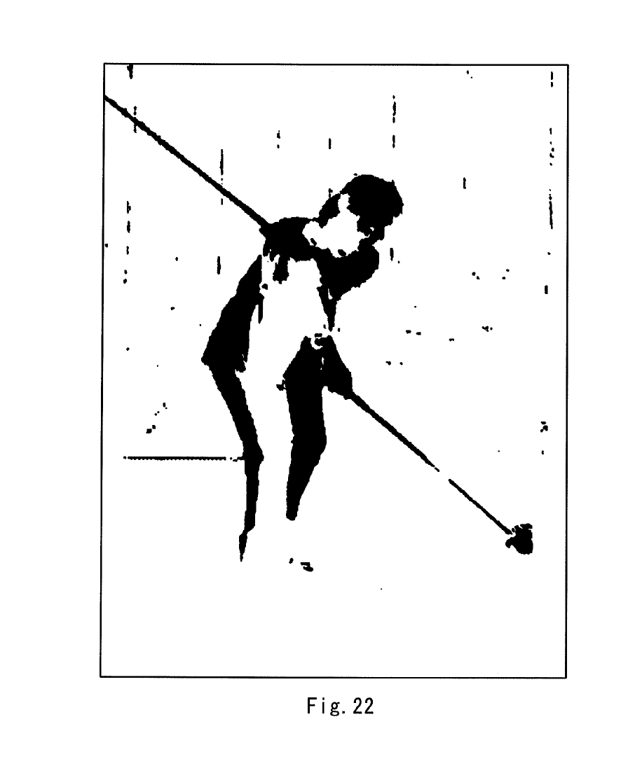

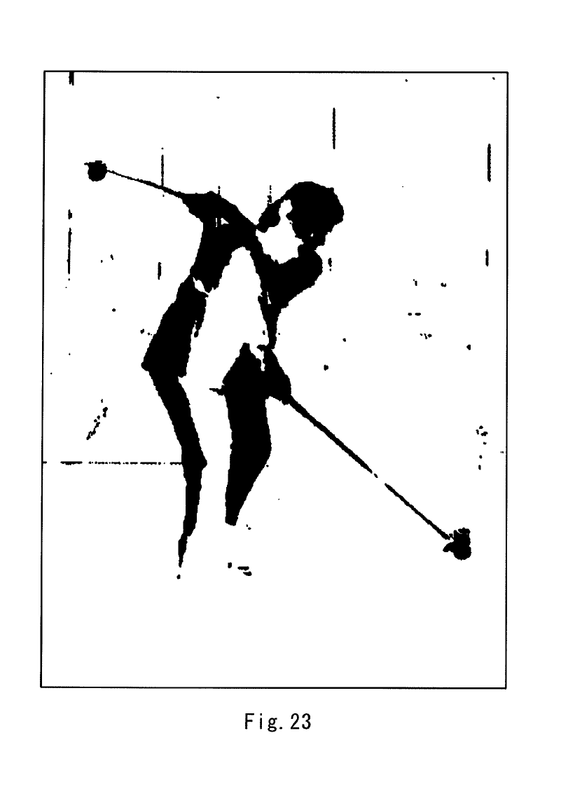

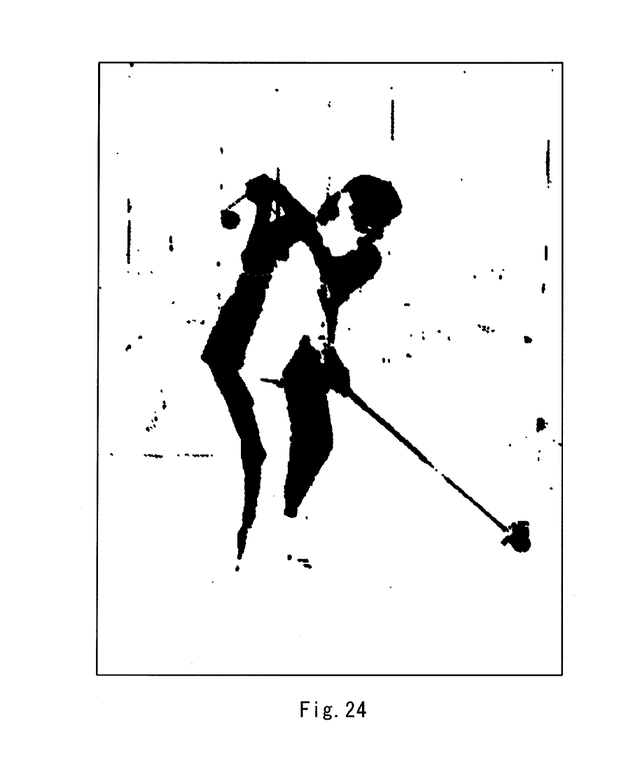

FIG. 19: A difference image between a 30th frame and the reference frame
FIG. 20: A difference image between a 39th frame and the reference frame
FIG. 21: A difference image between a 41th frame and the reference frame
FIG. 22: A difference image between a 43th frame and the reference frame
FIG. 23: A difference image between a 52th frame and the reference frame
FIG. 24: A difference image between a 57th frame and the reference frame

In these difference images, the number of pixels of a longitudinal y is 640, and the number of pixels of a transversal x is 480. These difference images are subjected to Hough transform (STEP642). A straight line corresponding to the shaft 34 can be calculated by the Hough transform. In each of difference screens, the existence or nonexistence of the straight line satisfying the following conditions is decided (STEP643).

θ: 5 degrees or greater and 85 degrees or less

ρ: no specification

x: 0 or greater and 240 or less

y: 0 or greater and 320 or less

number of votes: equal to or greater than 100
In the frame from which the straight line satisfying these conditions is extracted, the shaft 34 is located on a left side than a waist of the golf player 24. A frame (hereinafter, referred to as a “matching frame”) after the frame of the address, from which the straight line satisfying these conditions is extracted first, is the check frame. A frame after the matching frame by a predetermined number may be determined as the check frame. In a frame after the matching frame by 2, it has been clear experientially that a left arm of the right-handed golf player 24 is almost horizontal. The outline of the check frame is determined (STEP7), and the quality of the swing is decided (STEP8).

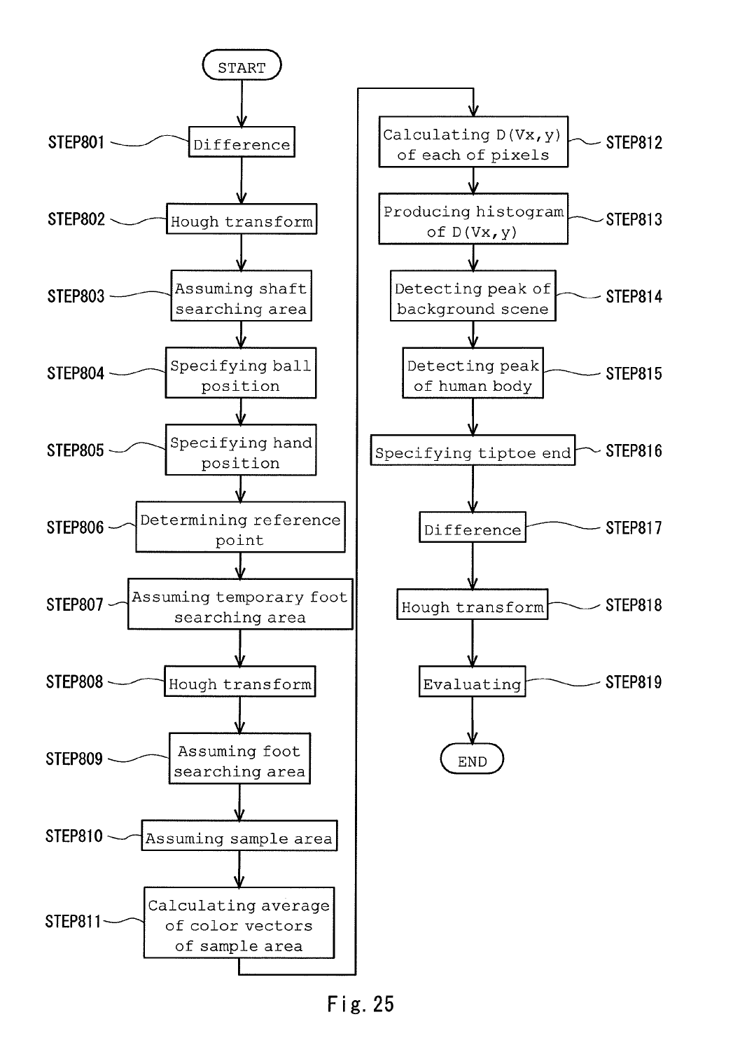

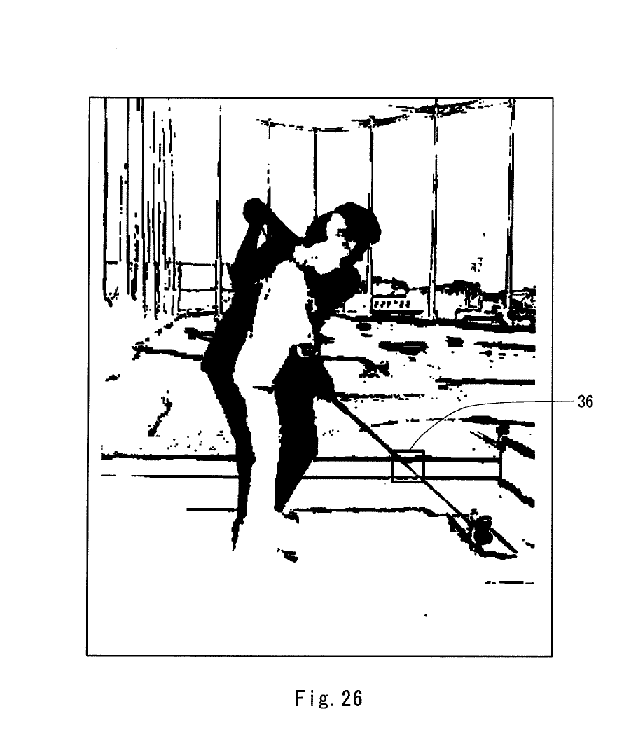

Hereinafter, an example of a decision (STEP8) will be described with reference to FIG. 25. Difference processing is conducted between the frame of the address and the frame of the top (STEP801). An image obtained by the difference is shown in FIG. 26. The image is subjected to Hough transform (STEP802). Conditions in the Hough transform are as follows.

θ: 35 degrees or greater and 55 degrees or less

x: 200 or greater and 480 or less

y: 250 or greater and 530 or less

A straight line corresponding to the shaft 34 in the address is extracted by the Hough transform.

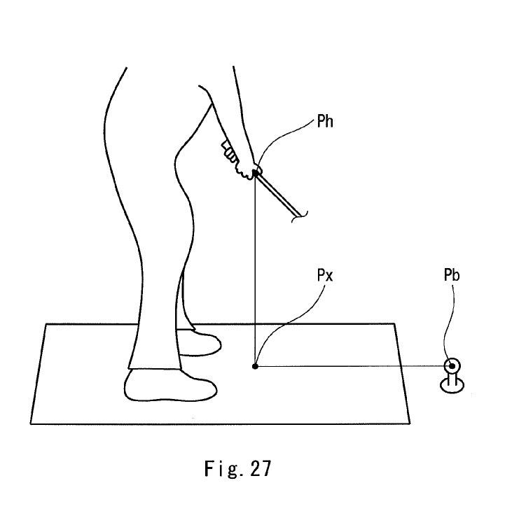

A shaft searching area 36 having a center at a middle point of the straight line is assumed (STEP803). As is apparent from FIG. 26, the searching area 36 is a square. In the embodiment, the size of the shaft searching area 36 is 21×21. The shaft searching area 36 is gradually moved in a direction approaching a ball along the straight line. A white area of a golf ball is extracted in the frame of the top. Thereby, a position of the golf ball is specified (STEP804). Furthermore, the shaft searching area 36 is gradually moved in a direction going away from the ball along the straight line. A position having a difference in equal to or greater than 70% of the pixel in the shaft searching area 36 is defined as a hand position (STEP805). A reference point Px is determined based on the ball position and the hand position (STEP806). As shown in FIG. 27, an intersecting point of a straight line passing through a ball position Pb and extending in a horizontal direction and a straight line passing through a hand position Ph and extending in a vertical direction is the reference point Px. When the golf ball is hardly recognized by a color, a circle (that is, an outline of the golf ball) may be extracted by the Hough transform.

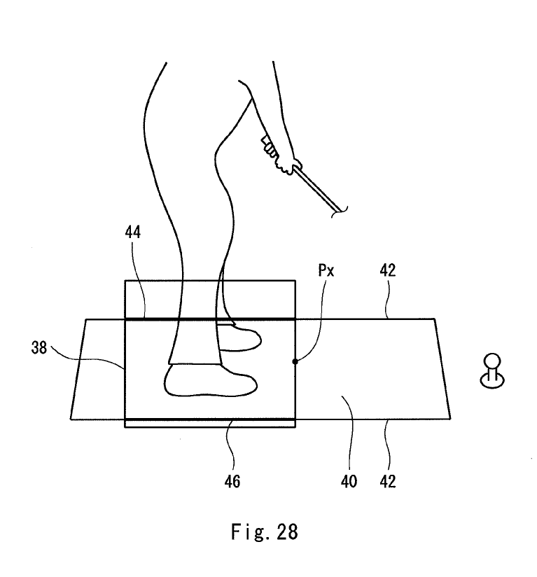

A temporary foot searching area 38 is assumed based on the reference point (STEP807). The temporary foot searching area 38 is shown in FIG. 28. The temporary foot searching area 38 is a rectangle. When a coordinate of the reference point Px is defined as (x₀, y₀), coordinates of four vertices of the rectangle are as follows.

(x₀−145,y₀−40)

(x₀,y₀−40)

(x₀−145,y₀+60)

(x₀,y₀+60)

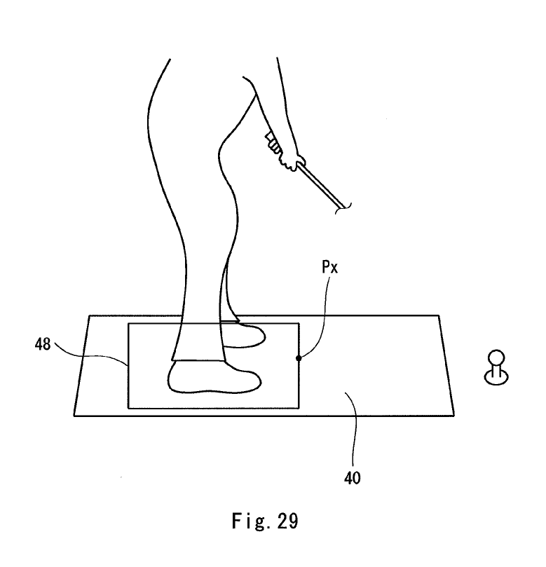

Next, Hough transform is conducted (STEP808). Two straight lines 44 and 46 corresponding to an edge 42 of artificial grass 40 are extracted by the Hough transform. These straight lines 44 and 46 are shown in FIG. 28. A true foot searching area is assumed based on these straight lines 44 and 46 and the temporary foot searching area 38 (STEP809). The foot searching area 48 is shown in FIG. 29. The foot searching area 48 includes no ground other than the artificial grass 40.

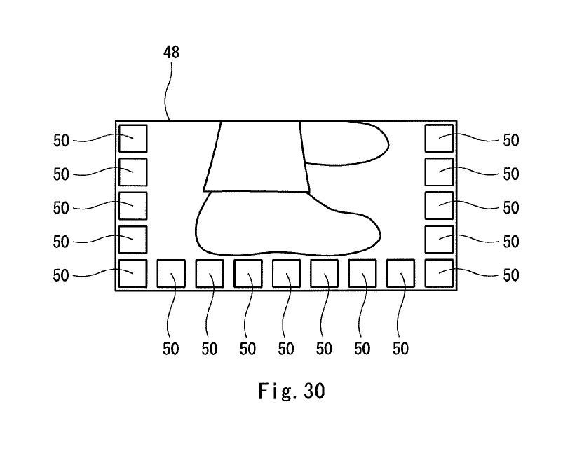

The enlarged foot searching area 48 is shown in FIG. 30. Sample areas 50 are assumed in the foot searching area 48 (STEP810). Seventeen sample areas 50 are shown in FIG. 30. Each of the sample areas 50 includes the artificial grass 40. Each of the sample areas 50 includes no foot (shoe) of the golf player 24.

An average of color vectors is calculated in each of the sample areas 50 (STEP811). Values of S1 to S17 are obtained by calculating the average of the seventeen sample areas 50.

A sum D (V_{x,y}) for pixels in the foot searching area 48 is calculated based on the following numerical expression (STEP812).

$$D ( {V}_{x , y} ) = {\sum }_{m = 1}^{m = 17} ( \vert {V}_{x , y} - {S}_{m} \vert \times {W}_{m} )$$

In the numerical expression, V_{x,y} is a color vector of a pixel (x, y); Sm is an average of a color vector of a m-th sample area 50; and Wm is a weighting factor. An example of a numerical expression calculating the weighting factor will be shown below. A calculating formula of the weighting factor when m is 3 is shown for convenience of description.

$$( \begin{matrix}{W}_{1} \\ {W}_{2} \\ {W}_{3}\end{matrix} ) = {( \begin{matrix}\vert {S}_{1} - {S}_{1} \vert & \vert {S}_{2} - {S}_{1} \vert & \vert {S}_{3} - {S}_{1} \vert \\ \vert {S}_{1} - {S}_{2} \vert & \vert {S}_{2} - {S}_{2} \vert & \vert {S}_{3} - {S}_{2} \vert \\ \vert {S}_{1} - {S}_{3} \vert & \vert {S}_{2} - {S}_{3} \vert & \vert {S}_{3} - {S}_{3} \vert\end{matrix} )}^{- 1} ( \begin{matrix}k \\ k \\ k\end{matrix} )$$

In the numerical expression, k is calculated by the following numerical expression.

k=(k1+k2+k3)/3

k1, k2, and k3 are calculated by the following numerical expression. k is an average of sums of the difference values between the sample areas 50.

|S₁−S₁|+|S₂−S₁|+|S₃−S₁|=k1

|S₁−S₂|+|S₂−S₂|+|S₃−S₂|=k2

|S₁−S₃|+|S₂−S₃|+|S₃−S₃|=k3

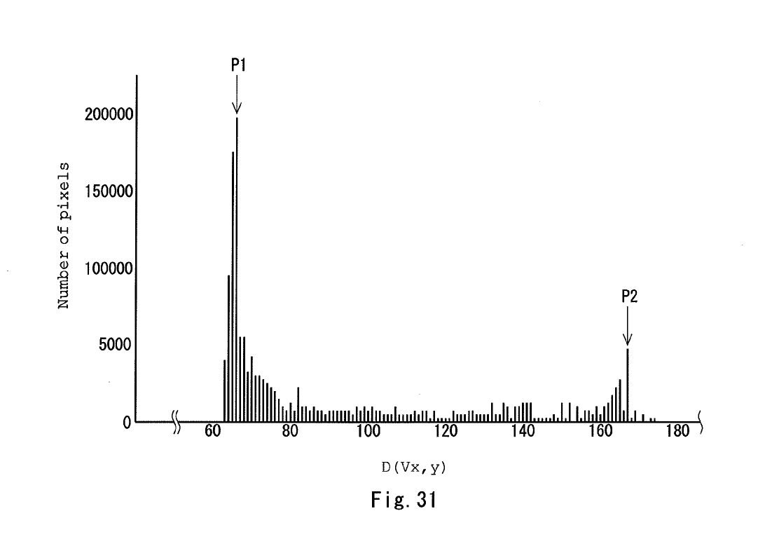

A histogram of the sum D (V_{x,y}) is produced (STEP813). The histogram is shown in FIG. 31. In the histogram, a horizontal axis is the sum D(V_{x,y}), and a vertical axis is the number of pixels. In the histogram, normalization for setting the maximum value of the sum D (V_{x,y}) in the foot searching area 48 to 255 is conducted. In the histogram, a peak P1 of the background scene is obtained by using the value k (STEP814). Furthermore, a peak P2 of the human body is obtained (STEP815). The peak P2 of the human body is the sum D (V_{x,y}) with the highest frequency in equal to or greater than (k+10). The sum D (V_{x,y}) obtained by dividing the sum D (V_{x,y}) of the peak P1 and the sum D (V_{x,y}) of the peak P2 at 1:4 is defined as a boundary. The pixel of the sum D (V_{x,y}) smaller than the boundary is regarded as the background scene. The pixel of the sum D (V_{x,y}) greater than the boundary is regarded as the human body. In other words, the determination of the boundary is specification of a tiptoe end of a golf shoe (STEP816).

In the method, the color of the background scene is determined based on the large number of sample areas 50. A sunny place and a shade may exist in the background scene. In this case, the color is largely different according to places. The objective average of the color can be obtained by determining the color of the background scene based on the large number of sample areas 50.

The number of the sample areas 50 is not restricted to 17. In respect of that the objective average can be obtained, the number of the sample areas 50 is preferably equal to or greater than 5, and particularly preferably equal to or greater than 10. In respect of facility of calculation, the number is preferably equal to or less than 100, and particularly preferably equal to or less than 50.

In the method, a weighting factor is used in calculation of the sum D (V_{x,y}). Even when a group of the large number of sample areas 50 having a closer mutual color and a group of a small number of sample areas 50 having a closer mutual color coexist, the objective sum D (V_{x,y}) can be calculated by using the weighting factor.

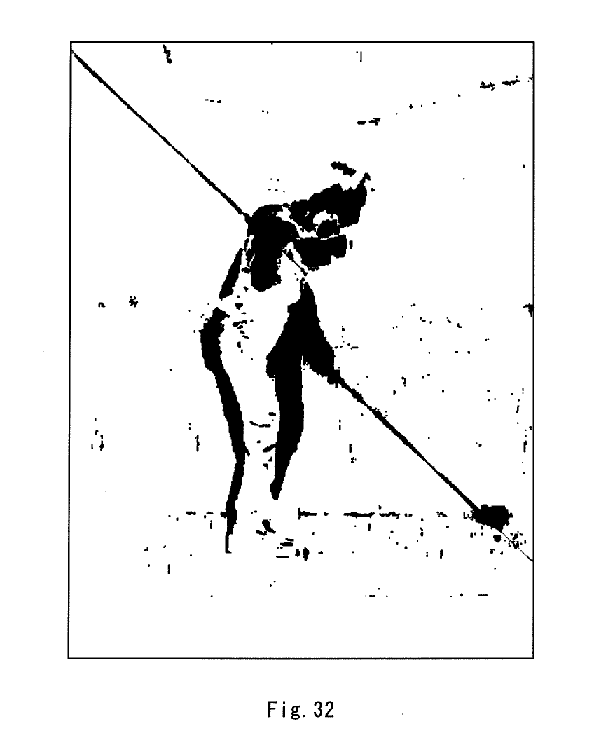

Difference processing is conducted between the frame in which the left arm is horizontal in the takeback and the frame of the address (STEP817). A difference image obtained by the difference processing is shown in FIG. 32. The image is subjected to Hough transform (STEP818). A straight line corresponding to the shaft 34 of the frame in which the left arm is horizontal in the takeback is extracted by the Hough transform.

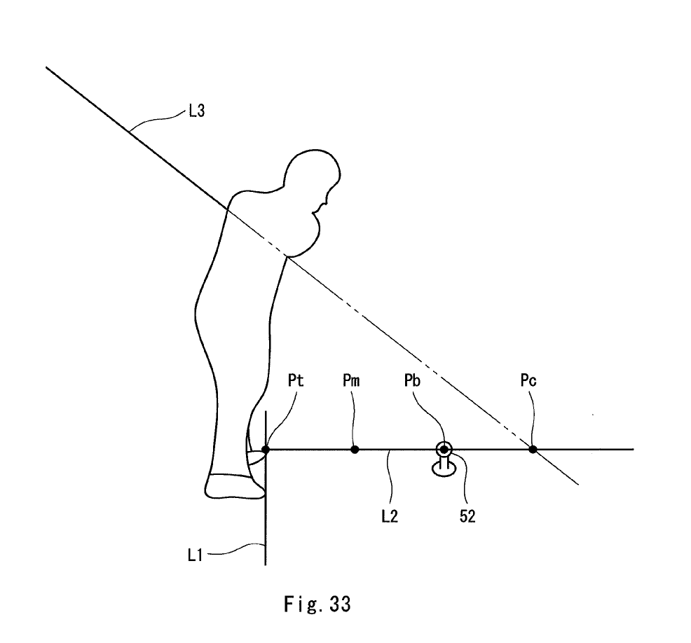

A swing is evaluated based on the straight line (STEP819). As shown in FIG. 33, in the evaluation, a straight line L1 passing through the tiptoe ends is assumed. Furthermore, a straight line L2 being perpendicular to the straight line L1 and passing through a central point Pb of a golf ball 52 is assumed. An intersecting point of the straight line L1 and the straight line L2 is a point Pt. A middle point of the point Pt and the point Pb is a point Pm. A straight line L3 corresponding to the shaft 34 of the frame in which the left arm is horizontal in the takeback is extended, and an intersecting point Pc of the extended line and the straight line L2 is determined. Quality of a posture of the golf player 24 is evaluated based on a position of the intersecting point Pc. An example of specific evaluation reference will be shown below.

(1) A case where the intersecting point Pc is on a left side than the point Pm.

A swing is upright. A flat swing should be kept.

(2) A case where the intersecting point Pc is between the point Pm and the point Pb.

A swing is good.

(3) A case where the intersecting point Pc is on a right side than the point Pb.

A swing is flat. An upright swing should be kept. The golf player 24 corrects the swing based on the evaluation.

The determination of the check frame enables swing diagnosis at various positions. For example, the quality of the swing may be decided by an angle between the straight line corresponding to the shaft 34 in the address and the straight line corresponding to the shaft 34 in the downswing.

Although the calculating part 16 of the server 6 conducts each of processings in the embodiment, the calculating part 16 of the mobile telephone 4 may conduct each of the processings. In the case, the connection of the mobile telephone 4 and the server 6 is unnecessary.

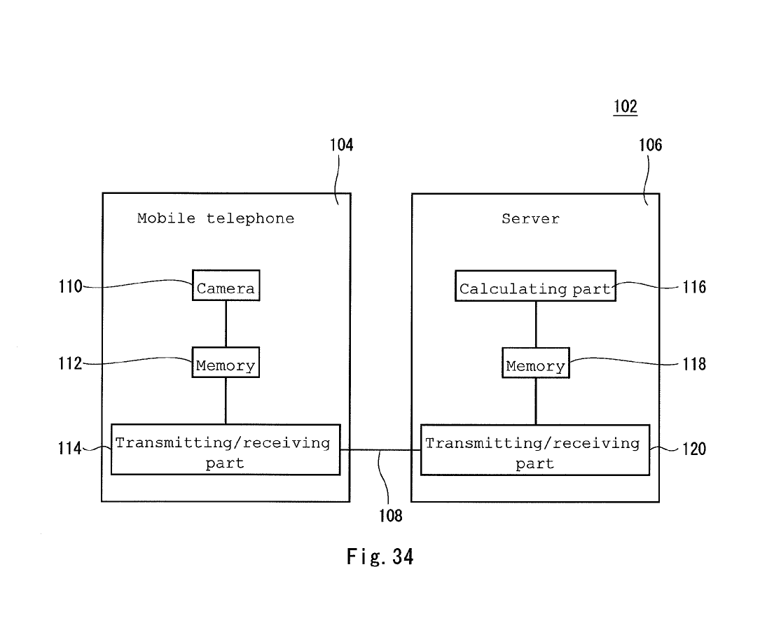

A system 102 shown in FIG. 34 is provided with a mobile telephone 104 and a server 106. The mobile telephone 104 and the server 106 are connected each other via a communication line 108. The mobile telephone 104 is provided with a camera 110, a memory 112, and a transmitting/receiving part 114. Specific examples of the memory 112 include a RAM, an SD card (including a mini SD and a micro SD or the like), and other memory medium. The server 106 is provided with a calculating part 116, a memory 118, and a transmitting/receiving part 120.

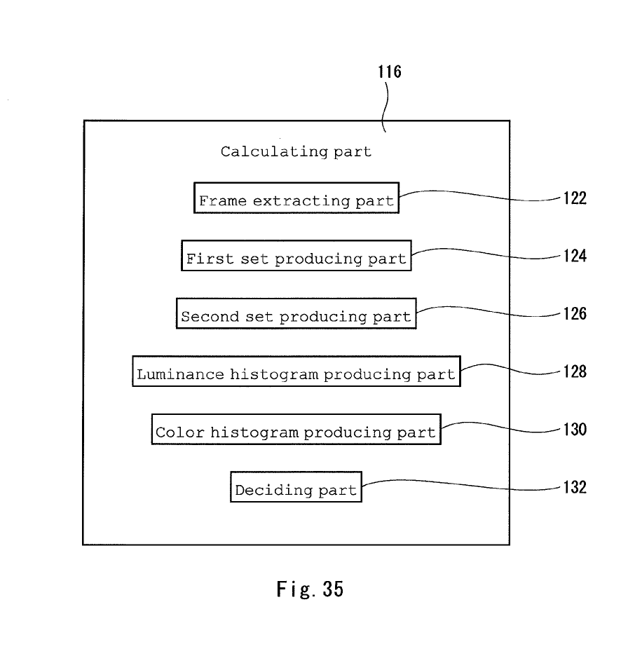

The calculating part 116 is typically a CPU. The calculating part 116 is shown in FIG. 35. The calculating part 116 has a frame extracting part 122, a first set producing part 124, a second set producing part 126, a luminance histogram producing part 128 (a first histogram producing part), a color histogram producing part 130 (a second histogram producing part), and a deciding part 132.

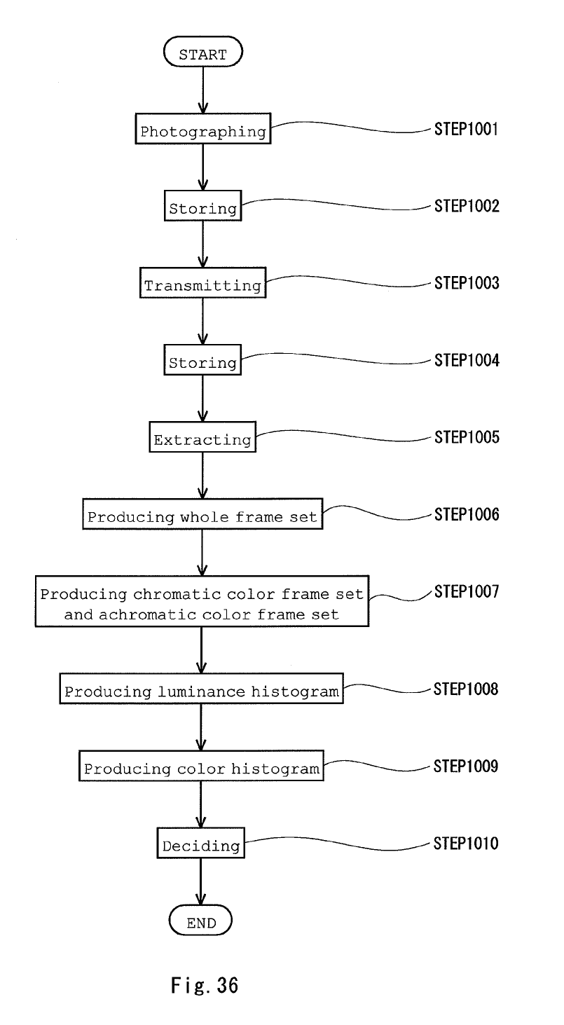

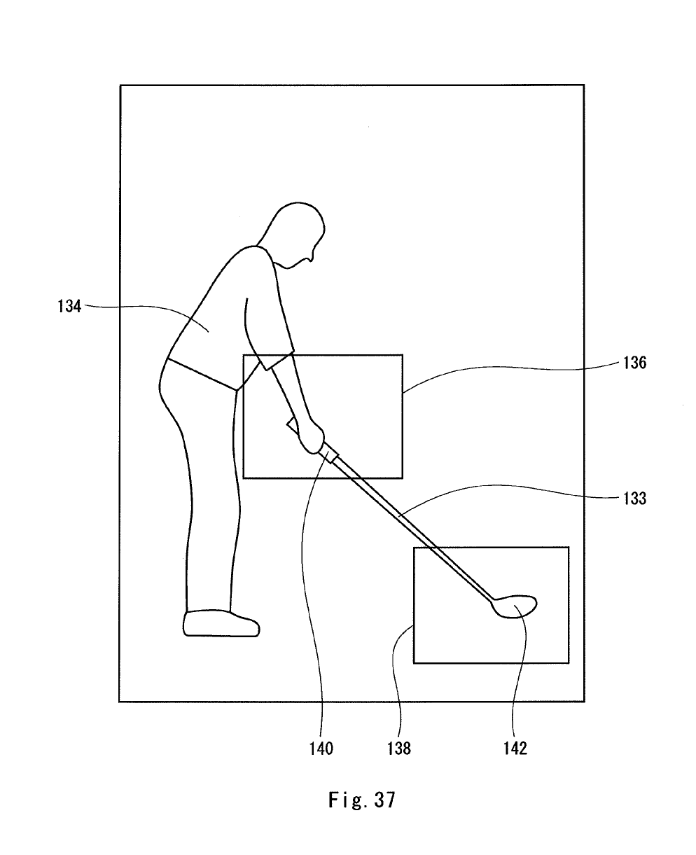

A flow chart of a silhouette extracting method conducted by the system 102 of FIG. 34 is shown in FIG. 36. In the extracting method, photographing is conducted by the camera 110 (STEP1001). A screen before photographing is started is shown in FIG. 37. The screen is displayed on a monitor (not shown) of the mobile telephone 104. An address of a golf player 134 having a golf club 133 is photographed on the screen. On the screen, the golf player 134 is photographed from a back side. A first frame 136 and a second frame 138 are shown on the screen. These frames 136 and 138 are displayed by software executed on a CPU (not shown) of the mobile telephone 104. These frames 136 and 138 contribute to a case where a photographer determines an angle of the camera 110. The photographer determines an angle of the camera 110 so that the first frame 136 includes a grip 140 and the second frame 138 includes a head 142. Furthermore, the frames 136 and 138 contribute to determination of a distance between the camera 110 and the golf player 134.

Photographing is started from the state shown in FIG. 37. After the photographing is started, the golf player 134 starts a swing. The photographing is continued until a golf ball (not shown) is hit and the swing is ended. Moving image data is obtained by the photographing. The data is stored in the memory 112 (STEP1002). The number of pixels of the moving image is, for example, 640×320.

The photographer or the golf player 134 operates the mobile telephone 104 to transmit the moving image data to the server 106 (STEP1003). The data is transmitted to the transmitting/receiving part 120 of the server 106 from the transmitting/receiving part 114 of the mobile telephone 104. The transmission is conducted via the communication line 108. The data is stored in the memory 118 of the server 106 (STEP1004).

The frame extracting part 122 extracts a large number of frames (that is, still image data) from the moving image data (STEP1005). The number of extracted frames per 1 second is 30 or 60. Each of the frames is subjected to correction processing if necessary. Specific examples of the correction processing include camera shake correction processing. These frames include a first frame and other frame photographed later than the first frame.

The first set producing part 124 produces a whole frame set including all the frames for each of the pixels (STEP1006). The second set producing part 126 determines whether each of the pixels of each of the frames has an achromatic color or a chromatic color, and produces a chromatic color frame set and an achromatic color frame set for each of the pixels (STEP1007).

The luminance histogram producing part 128 produces a luminance histogram (a first histogram) for the whole frame set (STEP1008). In the luminance histogram, a frequency is a frame number and a class is luminance (first color information). The luminance histogram may be produced based on other color information. The color histogram producing part 130 produces a color histogram (a second histogram) for the chromatic color frame set and the achromatic color frame set (STEP1009). In the color histogram, a frequency is a frame number; a class for the chromatic color frame set is hue (second color information); and a class for the achromatic color frame set is luminance (third color information). The class for the chromatic color frame set may be color information other than hue. The class for the achromatic color frame set may be color information other than luminance.

The deciding part 132 decides whether each of the frames of each of the pixels is a background scene or a photographic subject based on the luminance histogram and the color histogram (STEP1010). Hereinafter, main steps will be described in detail.

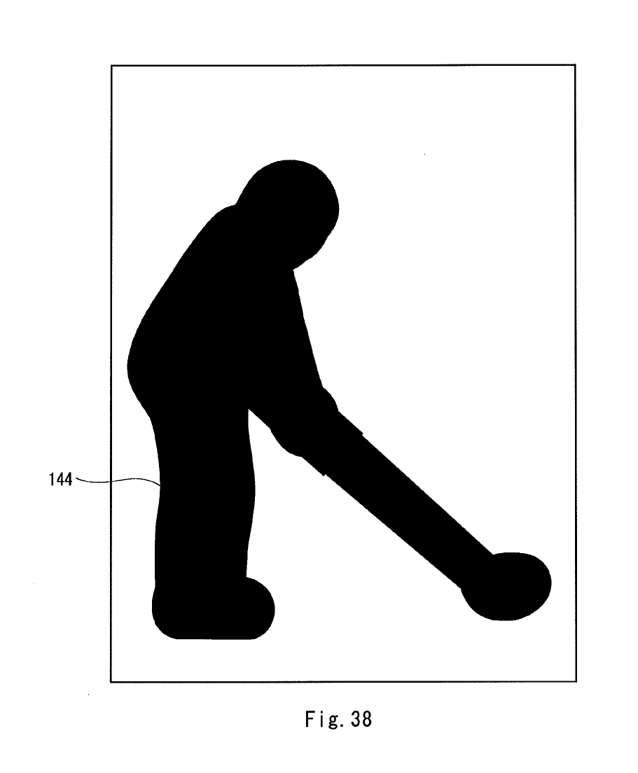

In the embodiment, a mask 144 shown in FIG. 38 is set in the first frame. As is apparent from FIG. 38, the mask 144 includes the golf player 134 and the golf club 133 shown in FIG. 37. An outer edge of the mask 144 is outside an outer edge of the golf player 134, and is outside an outer edge of the golf club 133. In determining whether each of the pixels has an achromatic color or a chromatic color, a pixel included in the mask 144 is not the object of calculation.

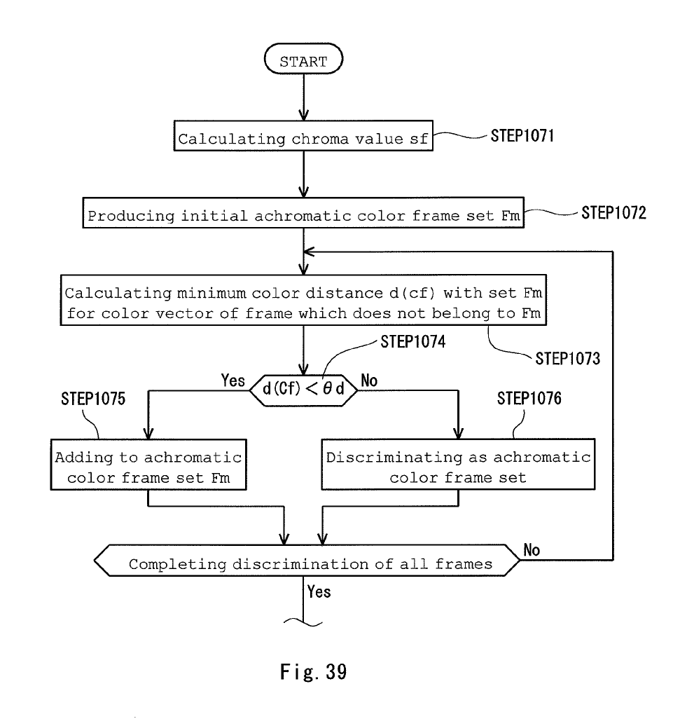

In a flow chart of FIG. 39, the details of a step (STEP1007) of determining whether each of the pixels has an achromatic color or a chromatic color, and producing an achromatic color frame set and a chromatic color frame set for each of the pixels are shown.

In the method, a chroma value sf of the pixel is calculated (STEP1071). For example, when silhouette is extracted based on sixty frames of the first frame to the 60th frame, the number of luminance values sf per one pixel is 60.

It is determined whether each of the sixty luminance values sf is smaller than a threshold value θs. The threshold value θs can be suitably determined. The threshold value θs used by the present inventor is 0.15. In other words, a color of a pixel in which a luminance value sf is less than 0.15 is regarded as an achromatic color or a substantial achromatic color. An initial achromatic color frame set Fm is obtained by the frame in which the luminance value sf is smaller than the threshold value θs (STEP1072).

A minimum color distance d (Cf) between a color vector Cf of a pixel in a frame f which does not belong to the achromatic color frame set Fm and the set Fm is calculated (STEP1073). The calculation is conducted based on the following numerical expression.

$$d ( {c}_{f} ) = {min}_{n ∈ {F}^{M }} ( \sqrt{( {c}_{f } - {c}_{n} ) {( {c}_{f} - {c}_{n} )}^{T}} )$$

n when a color distance between the frame f and n is the minimum in the achromatic color frame set Fm is searched based on the numerical expression.

It is decided whether the obtained d (Cf) is less than a threshold value θd (STEP1074). The threshold value θd can be suitably determined. The threshold value θd used by the present inventor is 3.0. In other words, a color of a pixel in which d (Cf) is less than 3.0 is regarded as an achromatic color or a substantial chromatic color. When d (Cf) is less than the threshold value θd, the frame is added to the achromatic color frame set Fm (STEP1075). The achromatic color frame set Fm is updated by the addition. When d (Cf) is equal to or greater than the threshold value θd, the frame is discriminated as the chromatic color frame set (STEP1076). The flow is repeated until the discrimination of all the frames as the chromatic color and the achromatic color is completed.

The flow shown in FIG. 39 is conducted for all the pixels except the mask 144. For example, when the number of the pixels except a mouse is 150000, and the number of the frames is 60, luminance values sf of 9000000 (15000×60) are calculated.

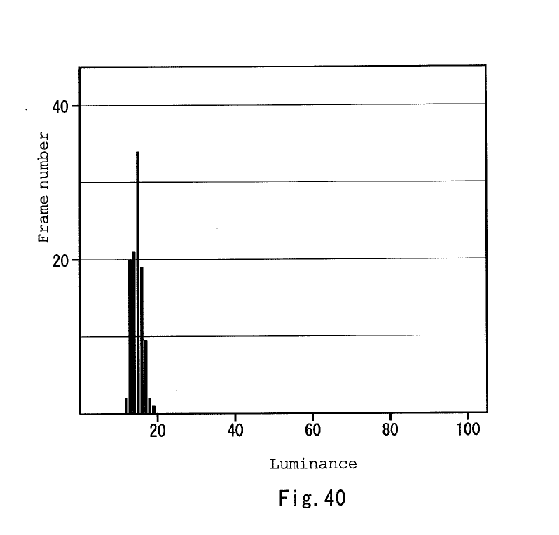

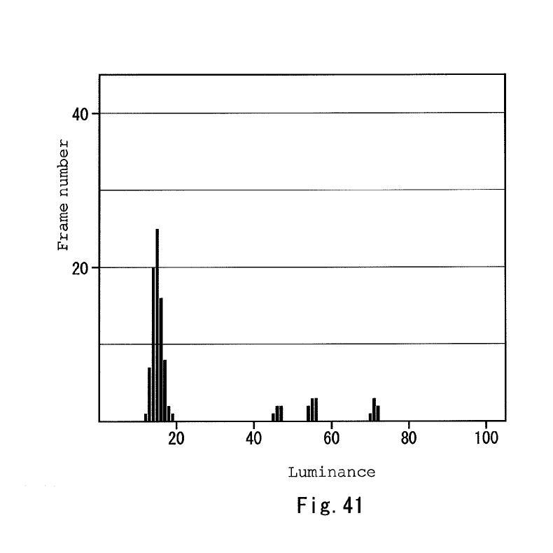

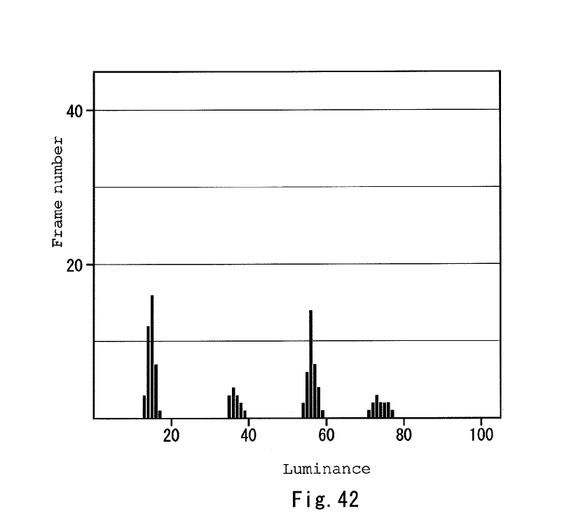

The luminance histogram producing part 128 produces a luminance histogram for the whole frame set (STEP1008). An example of the luminance histogram for a certain pixel is shown in FIG. 40. In the luminance histogram, a class is luminance. The histogram includes 100 classes of 1 to 100. In the histogram, a frequency is a frame number. The frequency may be subjected to smoothing processing. An example of a luminance histogram of another pixel is shown in FIG. 41. An example of a luminance histogram of still another pixel is shown in FIG. 42. In each of the luminance histograms, the total number of the frames is 98.

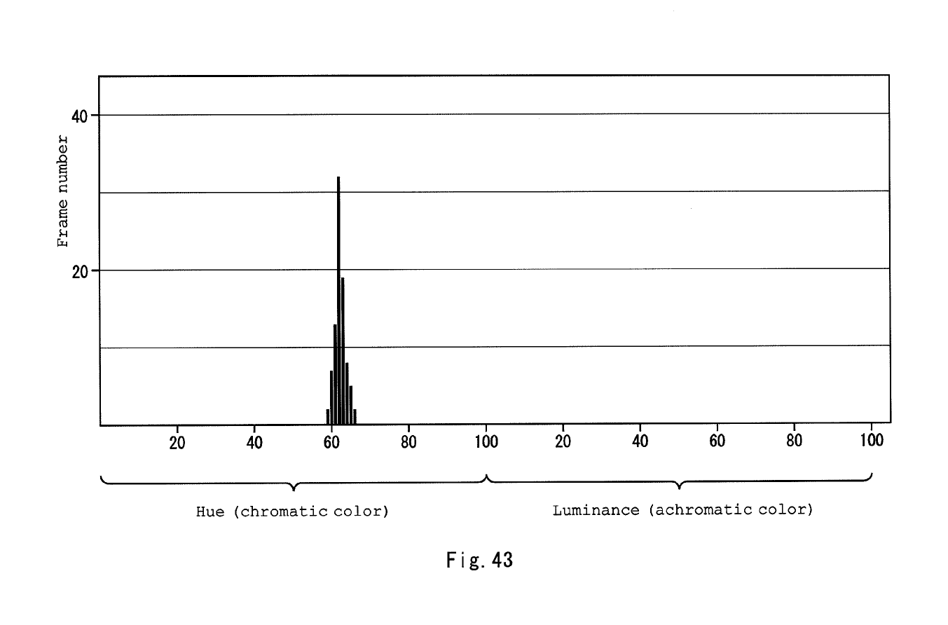

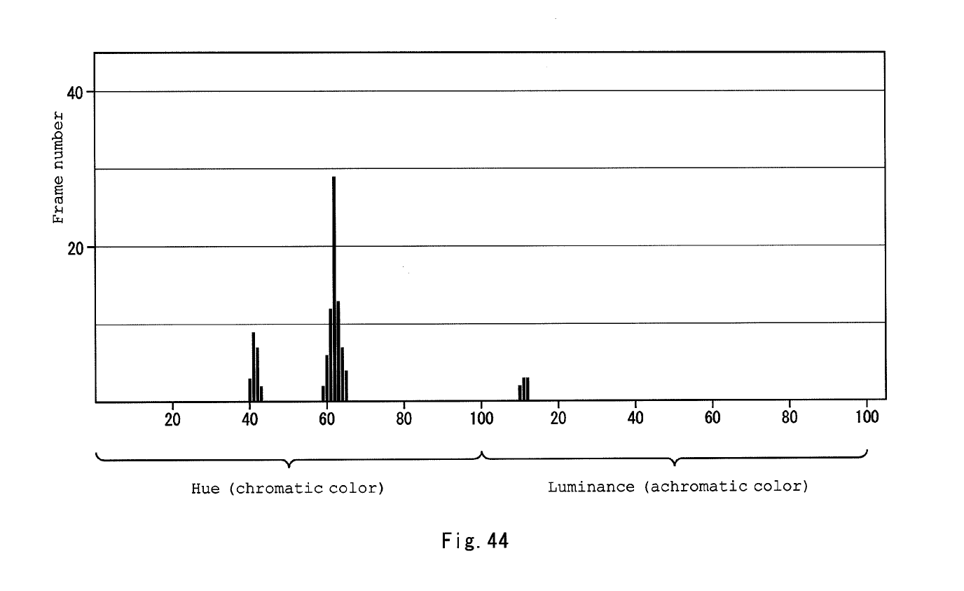

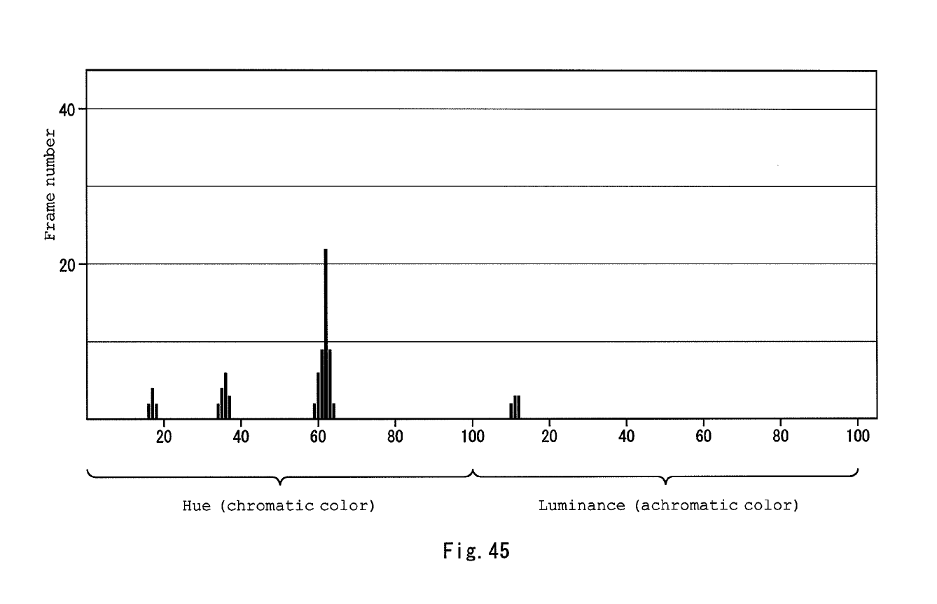

The color histogram producing part 130 produces a color histogram for the achromatic color frame set and the achromatic color frame set (STEP1009). An example of the color histogram for a certain pixel is shown in FIG. 43. The color histogram is obtained by combining the histogram of the chromatic color frame set with the histogram of the achromatic color frame set. In the color histogram, the class of the chromatic color frame set is hue. The class of the hue includes 100 classes of 1 to 100. In the color histogram, the class of the achromatic color frame set is luminance. The class of the luminance includes 100 classes of 1 to 100. The total number of the classes is 200. In the color histogram, a frequency is a frame number. The frequency may be subjected to smoothing processing. An example of a color histogram of another pixel is shown in FIG. 44. An example of a color histogram of still another pixel is shown in FIG. 45. In each of the color histograms, the total of the frames is 98.

It is decided whether each of the pixels is the background scene or the photographic subject based on the luminance histogram and the color histogram (STEP1010). The decision is conducted by the deciding part 132. The decision includes a first stage, a second stage, and a third stage. Hereinafter, each of the stages will be described in detail.

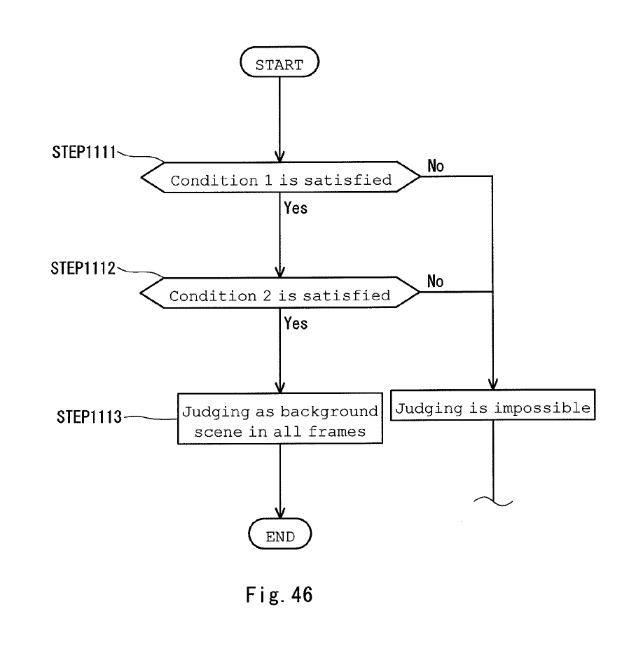

FIG. 46 is a flow chart showing the first stage. The first stage is conducted for each of the pixels. In the first stage, it is first judged whether a condition 1 is satisfied (STEP1111). The condition 1 is as follows.

Condition 1: In the luminance histogram, all the frames are included in a range in which a class width is equal to or less than 20.

Values other than “20” may be used as the class width.

In the luminance histogram of FIG. 40, all the frames are included in a range in which luminance is 12 to 19 (that is, a width is 8). Therefore, the luminance histogram satisfies the condition 1. In the luminance histogram of FIG. 41, the minimum value of the class is 12, and the maximum value thereof is 72. Therefore, the luminance histogram does not satisfy the condition 1. In the luminance histogram of FIG. 42, the minimum value of the class is 13 and the maximum value thereof is 77. Therefore, the luminance does not satisfy the condition 1.

Next, it is judged whether a condition 2 is satisfied (STEP1112). The condition 2 is as follows.

Condition 2: In the color histogram, all the frames are included in a range in which the class width is equal to or less than 20.

Values other than “20” may be used as the class width.

FIG. 43 is a color histogram for the pixel of FIG. 40. FIG. 44 is a color histogram for the pixel of FIG. 41. FIG. 45 is a color histogram for the pixel of FIG. 42. In the color histogram of FIG. 43, all the frames are included in a range in which hue is 59 to 66 (that is, a width is 7). Therefore, the color histogram satisfies the condition 2. In the color histogram of FIG. 44, the minimum value of the class of hue is 140, and the maximum value thereof is 65. Furthermore, in the histogram of FIG. 44, the class of luminance has a frequency. Therefore, the color histogram does not satisfy the condition 2. In the color histogram of FIG. 45, the minimum value of the class of hue is 16, and the maximum value thereof is 64. Furthermore, in the histogram of FIG. 45, the class of luminance has a frequency. Therefore, the color histogram does not satisfy the condition 2.

In the pixels shown in FIGS. 40 and 43, the luminance histogram satisfies the condition 1, and the color histogram satisfies the condition 2. When the golf player 134 swings, the golf player 134 moves. Both the golf player 134 and the background scene can be photographed in the pixel due to the motion. When both the golf player 134 and the background scene are photographed, the luminance or the hue of the pixel fluctuates widely. The pixel satisfying both the conditions 1 and 2 is a pixel in which the fluctuation of the luminance and the hue is small. In other words, it is considered that the golf player 134 is not photographed between the first frame and the final frame in the pixel. The pixel satisfying the conditions 1 and 2 is decided as the “background scene” in all the frames (STEP1113).

The luminance histogram cannot discriminate between the chromatic color and the achromatic color having the same luminance. However, the color histogram can discriminate between the chromatic color and the achromatic color. The color histogram cannot discriminate between the two chromatic colors having the same hue and the different luminance. However, the luminance histogram can discriminate between the two chromatic colors. When both the conditions 1 and 2 are satisfied in the silhouette extracting method according to the present invention, the pixel is decided as the “background scene” in all the frames. In other words, a decision is conducted by considering both the luminance histogram and the color histogram. Therefore, the pixel which is not the background scene is almost never falsely recognized as the background scene.

Even the pixel in which only the golf player 134 is photographed between the first frame and the final frame can satisfy the conditions 1 and 2. However, as described above, since the golf player 134 is subjected to masking by the mask 144, the pixel satisfying the conditions 1 and 2 can be judged as the “background scene” in all the frames.

The pixel in which both the golf player 134 and the background scene are photographed between the first frame and the final frame does not satisfy the condition 1 or 2. The decision of the pixel which does not satisfy the condition 1 or 2 is carried over to a second stage.

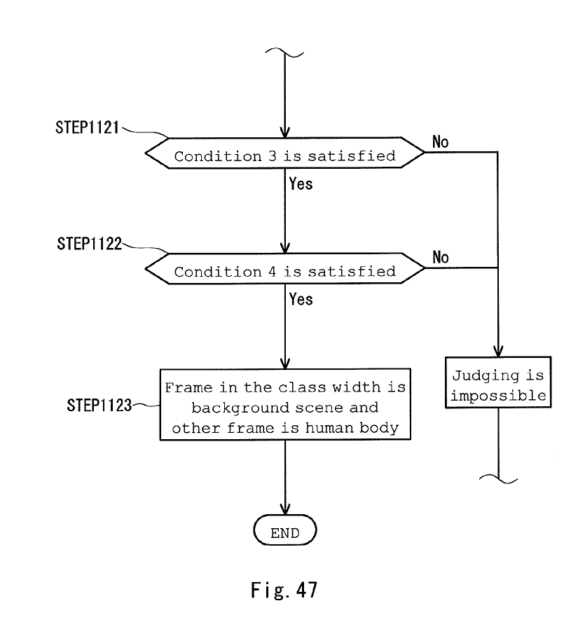

Hereinafter, the second stage will be described in detail. In the first stage, the pixel judged as “both the golf player 134 and the background scene are photographed” is further considered in the second stage. FIG. 47 is a flowchart showing the second stage. The second stage is conducted for each of the pixels. In the second stage, it is first judged whether a condition 3 is satisfied (STEP1121). The condition 3 is as follows.

Conditions 3: In the luminance histogram, a range in which the class width is equal to or less than 20 includes equal to or greater than 60% of all the frames.

Values other than “20” may be used as the class width. Values other than “60%” may be used as a ratio.

In the luminance histogram of FIG. 41, a range in which luminance is 12 to 19 (that is, a width is 8) includes 80 (that is, 81.6%) frames. Therefore, the condition 3 is satisfied. The condition 3 is not satisfied in the luminance histogram of FIG. 42.

Next, it is judged whether a condition 4 is satisfied (STEP1122). The condition 4 is as follows.

Condition 4: In the color histogram, a range in which the class width is equal to or less than 20 includes equal to or greater than 60% of all the frames.

Values other than “20” may be used as the class width. Values other than “60%” may be used as a ratio.

In the color histogram of FIG. 44, a range in which luminance is 59 to 65 (that is, a width is 7) includes 72 (that is, 73.5%) frames. Therefore, the condition 4 is satisfied. The condition 4 is not satisfied in the luminance histogram of FIG. 45.

In the pixels shown in FIGS. 41 and 44, the luminance histogram satisfies the condition 3, and the color histogram satisfies the condition 4. When the range in which the class width is equal to or less than 20 includes equal to or greater than 60% of all the frames, the fluctuation of the luminance or the hue is considered to be small in the pixel of the frame group in the class width. On the other hand, the luminance or the hue of the pixel of the frame group outside the class width is considered to be greatly different from the luminance or the hue of the pixel of the frame in the class width. It is considered that the background scene is mainly photographed in the pixel and the human body of the golf player 134 is temporarily photographed between the first frame and the final frame from the phenomenon. For the pixel satisfying the conditions 3 and 4, the frame in the class width is decided as the “background scene”, and the other frame is decided as the “photographic subject” (STEP1123).

The luminance histogram cannot discriminate between the chromatic color and the achromatic color having the same luminance. However, the color histogram can discriminate between the chromatic color and the achromatic color. The color histogram cannot discriminate between the two chromatic colors having the same hue and the different luminance. However, the luminance histogram can discriminate between the two chromatic colors. A decision is conducted based on both the conditions 3 and 4 in the silhouette extracting method according to the present invention. In other words, a decision is conducted by considering both the luminance histogram and the color histogram. Therefore, false recognition is suppressed.

The decision of the pixel presenting the histogram as shown in FIGS. 42 and 45 is carried over to a third stage.

Hereinafter, the third stage will be described in detail. The pixel carried over in the second stage and the pixel corresponding to the mask 144 are further considered in the third stage. Hereinafter, the pixel in which a decision of the “background scene” or the “photographic subject” has been already conducted is referred to as a “deciding completion pixel”. On the other hand, the pixel in which the decision of the “background scene” or the “photographic subject” has not yet been conducted is referred to as a “deciding noncompletion pixel”.

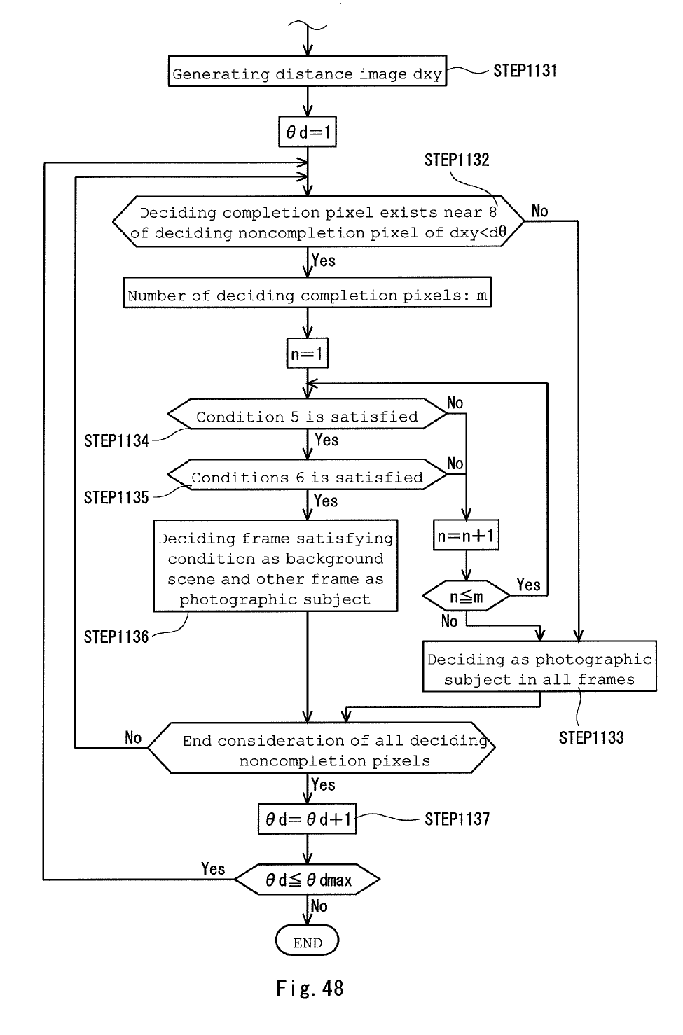

FIG. 48 is a flow chart showing the third stage. In the third stage, a distance image dxy is generated for the deciding noncompletion pixel (STEP1131). The distance image dxy is obtained by adding depth data to two-dimensional data. Herein, the depth data is a distance to a boundary.

When an initial value of the threshold value θd is 1, it is considered whether the deciding completion pixel exists near 8 of the deciding noncompletion pixel in which dxy is less than θd (STEP1132). Herein, “near 8” implies eight pixels placed at the left position, the upper left position, the upper position, the upper right position, the right position, the lower right position, the lower position, and the lower left position of the deciding noncompletion pixel.

When the deciding completion pixel does not exist near 8 at all, the pixel is decided as the “photographic subject” in all the frames (STEP1133). When one or two or more deciding completion pixels exist near 8, it is judged whether the following condition 5 is satisfied (TEP1134). The condition 5 is as follows.

Condition 5: A frame group satisfying the following numerical expressions exists in the luminance histogram.

min(LQ)>min(LB)−θw

max(LQ)<max(LB)+θw

In these numerical expressions, min (LQ) is the minimum value of the class width of the frame group in the luminance histogram of the deciding noncompletion pixel; max (LQ) is the maximum value of the class width of the frame group in the luminance histogram of the deciding noncompletion pixel; min (LB) is the minimum value of the class width of the frame group which is the background scene in the luminance histogram of one deciding completion pixel existing near 8; and max (LB) is the maximum value of the class width of the frame group which is the background scene in the luminance histogram of one deciding completion pixel existing near 8. θw is suitably set. The present inventor used 6 as θw.

When one or two or more deciding completion pixels exist near 8, it is further decided whether the following condition 6 is satisfied (STEP1135). The condition 6 is as follows.

Condition 6: A frame group satisfying the following numerical expressions exists in the color histogram.

min(CQ)>min(CB)−θw

max(CQ)<max(CB)+θw

In these numerical expressions, min (CQ) is the minimum value of the class width of the frame group in the color histogram of the deciding noncompletion pixel; max (CQ) is the maximum value of the class width of the frame group in the color histogram of the deciding noncompletion pixel; min (CB) is the minimum value of the class width of the frame group which is the background scene in the color histogram of one deciding completion pixel existing near 8; and max (CB) is the maximum value of the class width of the frame group which is the background scene in the color histogram of one deciding completion pixel existing near 8. θw is suitably set. The present inventor used 6 as θw.

The pixel of the frame group satisfying the conditions 5 and 6 is decided as the “background scene”. The pixel of the frame group which does not satisfy the conditions 5 and 6 is decided as the “photographic subject” (STEP1136). When either of the conditions 5 and 6 is not satisfied in the relationship with the deciding completion pixel, and the other deciding completion pixel exists near 8, it is decided whether the conditions 5 or 6 are satisfied in the relationship with the other deciding completion pixel.

After the consideration of the conditions 5 and 6 is completed for all the deciding noncompletion pixels, “1” is added to θd (STEP1137). A flow of from a consideration (STEP1132) of whether the deciding completion pixel exists near 8 of the deciding noncompletion pixel to a decision (STEP1136) is repeated. The repetition is conducted until θd reaches to θdmax. θdmax is the maximum value in the distance image.

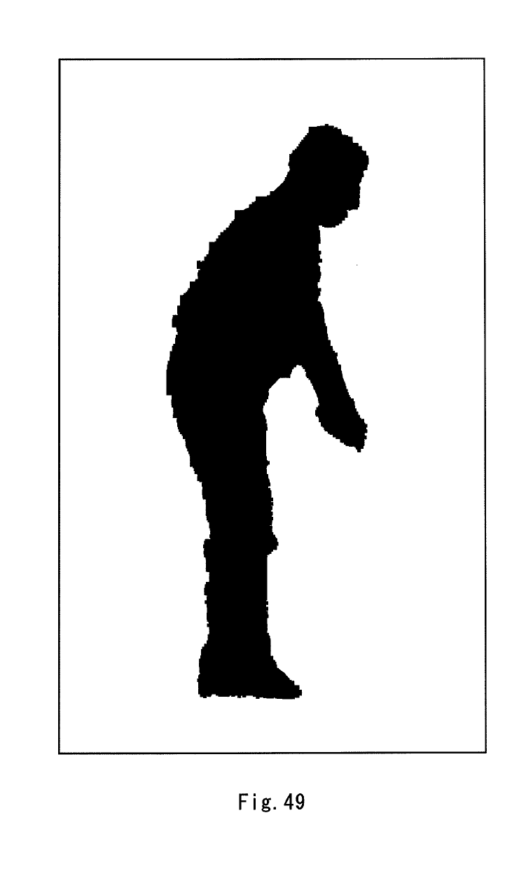

All the pixels of all the frames are discriminated as any one of the “background scene” and the “photographic subject” by the flow. The set of the pixels as the photographic subject is silhouette of the photographic subject in each of the frames. Silhouette of one frame is shown in FIG. 49. In FIG. 34, the pixel of the photographic subject is shown by black, and another pixel is shown by white. As is apparent from FIG. 49, the silhouette of the photographic subject (golf player 134) is almost faithfully reproduced by the method. The silhouette is used, and the swing of the golf player 134 can be diagnosed by the image processing. Since a period of time from the start to finish of the photographing is short, the weather is hardly changed sharply during the period. Therefore, false recognition resulting from the weather change is hardly generated.

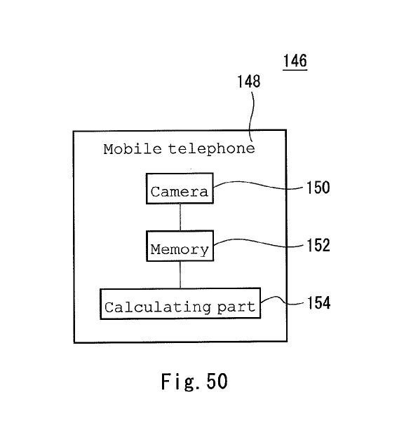

FIG. 50 is a conceptual view showing a silhouette extracting system 146 according to another embodiment of the present invention. The system 146 includes a mobile telephone 148. The mobile telephone 148 is provided with a camera 150, a memory 152, and a calculating part 154. Although not shown, the calculating part 154 includes a frame extracting part, a first set producing part, a second set producing part, a luminance histogram producing part, a color histogram producing part, and a deciding part as in the calculating part 116 shown in FIG. 35. The calculating part 154 has the same function as that of the calculating part 116 shown in FIG. 35. That is, the calculating part 154 extracts silhouette. Therefore, the connection of the mobile telephone 148 and the server 6 is unnecessary. If the photographer brings only the mobile telephone 148, the swing can be diagnosed on the moment.

The description hereinabove is merely for an illustrative example, and various modifications can be made in the scope not to depart from the principles of the present invention.

What is claimed is:

1. A diagnosing method of a golf swing comprising the steps of:
a camera photographing a golf player swinging a golf club to hit a golf ball and the golf club, to obtain image data;
a calculating part obtaining an edge image of a frame extracted from the image data;
the calculating part subjecting the edge image to binarization based on a predetermined threshold value to obtain a binary image; and
the calculating part subjecting the binary image to Hough transform processing to extract a position of a shaft.

2. A diagnosing system of a golf swing comprising:
(A) a camera photographing a golf player swinging a golf club to hit a golf ball and the golf club;
(B) a memory storing photographed image data; and
(C) a calculating part,
wherein the calculating part has:
(C1) a function for obtaining an edge image of a frame extracted from the image data;
(C2) a function for subjecting the edge image to binarization based on a predetermined threshold value to obtain a binary image; and
(C3) a function for subjecting the binary image to Hough transform processing to extract a position of a shaft.

3. A diagnosing method of a golf swing comprising the steps of:
a camera photographing a golf player swinging a golf club to hit a golf ball and the golf club in a state where a golf club head in an address is positioned in a reference area in a screen to obtain image data;
a calculating part obtaining an edge image of a frame extracted from the image data;
the calculating part subjecting the edge image to binarization based on a predetermined threshold value to obtain a binary image;
the calculating part subjecting the binary image to Hough transform processing to extract a position of a shaft of the golf club, and specifying a tip coordinate of the golf club;
the calculating part contrasting tip coordinates of different frames to determine a temporary flame in the address; and
the calculating part calculating color information in the reference area of each of frames by backward sending from a frame after the temporary frame by a predetermined number, and determining a frame in the address based on change of the color information.

4. The diagnosing method according to claim 3, further comprising the step of the calculating part using a frame after the frame in the address by a predetermined number as a reference frame, calculating a difference value between each of frames after the reference frame and the reference frame, and determining a frame of an impact based on change of the difference value.

5. The diagnosing method according to claim 4, further comprising the steps of the calculating part calculating a difference value between each of a plurality of frames before the frame of the impact and a previous frame thereof, and determining a frame of a top based on the difference value.

6. The diagnosing method according to claim 3, further comprising the steps of:
the calculating part calculating a difference value between each of a plurality of frames after the frame of the address and the frame of the address;
the calculating part subjecting the difference value of each of the frames to Hough transform processing to extract the position of the shaft; and
the calculating part determining a frame of a predetermined position during a takeback based on change of the position of the shaft.

7. A diagnosing system of a golf swing comprising:
(A) a camera photographing a golf player swinging a golf club to hit a golf ball and the golf club in a state where a golf club head in an address is positioned in a reference area in a screen;
(B) a memory storing the photographed image data; and
(C) a calculating part,
wherein the calculating part has:
(C1) a function for obtaining an edge image of a frame extracted from the image data;
(C2) a function for subjecting the edge image to binarization based on a predetermined threshold value to obtain a binary image;
(C3) a function for subjecting the binary image to Hough transform processing to extract a position of a shaft of the golf club, and specifying a tip coordinate of the golf club;
(C4) a function for contrasting tip coordinates of different frames to determine a temporary flame in the address; and
(C5) a function for calculating color information in the reference area of each of frames by backward sending from a frame after the temporary frame by a predetermined number, and determining a frame in the address based on change of the color information.

8. A diagnosing method of a golf swing comprising the steps of:
a camera photographing a golf player swinging a golf club to hit a golf ball and the golf club, to obtain image data;
a calculating part determining a frame of a predetermined position during a takeback from a frame extracted from the image data;
the calculating part extracting a position of a shaft of the golf club in the frame of the predetermined position;
the calculating part determining an intersecting point of an extended line of the shaft and a straight line passing through a tiptoe position of golf player and a position of the golf ball before an impact; and
the calculating part determining quality of a posture of the golf player in the predetermined position during the takeback based on a position of the intersecting point.

9. A silhouette extracting method comprising the steps of:
photographing an operating photographic subject together with a background scene to obtain a plurality of flames, each of the frames including a large number of pixels;
producing a whole frame set including all the frames for each of the pixels;
determining whether each of the pixels of each of the frames has an achromatic color or a chromatic color, and producing a chromatic color frame set and an achromatic color frame set for each of the pixels;
producing a first histogram in which a frequency is a frame number and a class is first color information, for the whole frame set;
producing a second histogram in which a frequency is a frame number; a class for the chromatic color frame set is second color information; and a class for the achromatic color frame set is third color information, for the chromatic color frame set and the achromatic color frame set; and
deciding whether the frame of each of the pixels is the background scene or the photographic subject based on the first histogram and the second histogram.

10. The silhouette extracting method according to claim 9, wherein the deciding step comprises the step of deciding whether each of the pixels is a pixel in which all the frames are the background scene or a pixel in which a frame as the background scene and a frame as the photographic subject are mixed, based on the first histogram and the second histogram.

11. The silhouette extracting method according to claim 10, wherein the deciding step comprises the steps of:
deciding whether the pixel in which the frame as the background scene and the frame as the photographic subject are mixed is a pixel in which a frame group as the background scene can be discriminated from a frame group as the photographic subject, based on the first histogram and the second histogram; and
discriminating the pixel in which the frame group as the background scene can be discriminated from the frame group as the photographic subject.

12. The silhouette extracting method according to claim 11, wherein the deciding step comprises the step of determining whether each of the frames of the pixel determined that the frame group as the background scene cannot be discriminated from the frame group as the photographic subject is the background scene or the photographic subject, based on the relationship between the pixel and another pixel adjacent to the pixel.

13. A silhouette extracting system comprising:
(A) a camera for photographing an operating photographic subject together with a background scene;
(B) a memory storing photographed image data; and
(C) a calculating part,
wherein the calculating part comprises:
(C1) a frame extracting part extracting a plurality of frames including a large number of pixels from the image data;
(C2) a first set producing part producing a whole frame set including all the frames for each of the pixels;
(C3) a second set producing part determining whether each of the pixels of each of the frames has an achromatic color or a chromatic color, and producing a chromatic color frame set and an achromatic color frame set for each of the pixels;
(C4) a first histogram producing part producing a first histogram in which a frequency is a frame number and a class is first color information, for the whole frame set;
(C5) a second histogram producing part producing a second histogram in which a frequency is a frame number; a class for the chromatic color frame set is second color information; and a class for the achromatic color frame set is third color information, for the chromatic color frame set and the achromatic color frame set; and
(C6) a deciding part deciding whether each of the frames of each of the pixels is the background scene or the photographic subject based on the first histogram and the second histogram.
